(19) United States
(12) Patent Application Publication
(10) Pub. No.: US 2025/0013995 A1
(43) Pub. Date: Jan. 9, 2025

(54) DIGITAL CURRENCY

(71) Applicant: David CHAUM, Sherman Oaks, CA (US)

(72) Inventor: David CHAUM, Sherman Oaks, CA (US)

(21) Appl. No.: 18/712,282

(22) PCT Filed: Nov. 22, 2022
(86) PCT No.: PCT/US2022/050698

§ 371 Date: May 22, 2024

Related U.S. Application Data
(60) Provisional application No. 63/281,786, filed on Nov. 22, 2021.
(60) Provisional application No. 63/281,793, filed on Nov. 22, 2021.
(60) Provisional application No. 63/281,818, filed on Nov. 22, 2021.
(60) Provisional application No. 63/282,215, filed on Nov. 23, 2021.
(60) Provisional application No. 63/284,715, filed on Dec. 1, 2021.
(60) Provisional application No. 63/295,736, filed on Dec. 31, 2021.
(60) Provisional application No. 63/298,688, filed on Jan. 12, 2022.
(60) Provisional application No. 63/300,120, filed on Jan. 17, 2022.
(60) Provisional application No. 63/300,714, filed on Jan. 19, 2022.
(60) Provisional application No. 63/307,210, filed on Feb. 7, 2022.
(60) Provisional application No. 63/358,187, filed on Jul. 4, 2022.
(60) Provisional application No. 63/424,196, filed on Nov. 10, 2022.

(51) Int. Cl. G06Q 20/06; G06Q 20/10

(52) U.S. Cl. CPC G06Q 20/065; G06Q 20/108

(57) ABSTRACT

The Central Bank Digital Currency (CBDC) introduced here is software only and anonymous—yet aggregation of amounts larger than those issued each user is thwarted. Each user has the ability to undo the anonymity of any value they should obtain, and this ability is in effect irrevocable even if the user wishes to give it up, which makes value obtained from multiple users risky to hold or spend. If the value issued a user has already been spent by someone other than the user, for instance, the user can at least reveal where it was spent; but if the value is not already spent, the user can spend it first thereby preventing anyone from spending it later.

### FIELD OF THE INVENTION

A central bank digital currency (CBDC) is provided that allows entities such as central banks to control the supply of money and have assurances that there is no counterfeiting, even when facing attacks by a quantum computer.

### BACKGROUND ART

Ecash technology was used by major commercial banks in the 1990's. The use of blind signatures was developed in the 1980. However, improvements in these technologies are needed now and the present inventions provides a number of improvements in this regard.

### SUMMARY OF THE INVENTION

The inventive system builds on and improves the eCash technology used by some major commercial banks in the 1990's, which introduced such “digital bearer” instruments that are withdrawn “blinded” and so only entered in a central database when deposited. Our CBDC architecture differs from that of earlier eCash in that all consumer and merchant interaction is with commercial banks, while money creation and the database of deposited money are provided exclusively by the central bank. Commercial banks authenticated their customers and monitor the extent of withdrawals and deposits. Initial enrolment of consumers is ideally by a visit to the branch of a commercial bank where they are known or identified.

The new type of CBDC introduced here can be considered “software only,” as it does not rely on special hardware for system security. Each what may here be called “party” to the system—central bank, commercial bank, merchant or user—would, however, stand to lose money if their keys were somehow compromised. To protect their keys, some users and merchants may choose commercially-available key protection devices, such as digital wallets sometimes built into smartphones. Banks can be expected to continue to use hardware devices for such purposes.

Since it is software only, cost can be low. Performance is not an issue, since computers of the 1990's were able to handle the transaction speeds and database sizes. The spent coins are stored only until the key set that validated them is changed, such as through a rolling annual schedule. Since transactions are essentially independent of each other, the amount of additional processing power and bandwidth needed grows by the same amount for each additional spend or deposit transaction per second. This additional power is simply achieved by adding more hardware, called database partitioning or sharding, and with so-called consistent hashing, hardware additions need not be disruptive. Any underlying database technology can be used, whether conventional or distributed such as via blockchain.

A user can make payments to merchants with our CBDC while the user remains anonymous, even if the merchant and banks try to discover user identity from all payment information that the system has access to. This is believed highly desirable in any replacement for banknotes in a free society.

The central bank interfaces directly only to commercial banks, neither directly to users nor merchants. The commercial banks in turn perform Know-Your-Customer (KYC) checks and ensure AML/CFT compliance. However, if a single user were somehow hypothetically to be able to gain control of large amounts of CBDC, such compliance provisions would then of course be circumvented and their whole purpose obviated. Preventing such aggregation of CBDC by one or a few users implies, at the very least, that no small number of users should be able to withdraw too large an amount of spendable CBDC, since they could be, for instance, leaders of criminal organizations or their minions.

While it is easy for banks to simply limit the amounts explicitly withdrawn by each user, here is, however, a more insidious potential threat allowing a single user to aggregate control large amounts of CBDC. Many individual users could be tricked by phone malware to insert keys of the aggregator (not to mention scenarios where they are otherwise motivated to include such malware). This would let CBDC be irrevocably and untraceably syphoned off from users by a criminal app. For instance, the apps could build special spending keys into CBDC as part of withdrawal or as part of legitimate or inflated change or refunds by merchants. The threat model of the protocols presented, accordingly, includes such apps and requires a structural solution.

The solution introduced here ensures that account owners will always be able to spend or at least allow tracing of anything that has been obtained from their respective accounts. To achieve this, the user secret key must remain known to, or at least accessible to, the actual person not just their phone. The protocols and infrastructure are specially set up so that, having the user secret key, the user can simply use any phone to re-construct any digital cash that was issued to or returned to that user. This means for one thing that if a user's cash has already been spent by someone other than the user, the user can at least allow irrefutable tracing of where it was spent. For another, it means that if the cash was not already spent, the user has various options: spend or deposit it themselves and optionally help entrap those who might try to spend it later.

A simple example procedure for when a user initially signs-up to get CBDC includes a user writing a list of about 20 random words, which will provide access to the user's private key. The user picks the words for the list, such as from those printed on the form booklet where the user writes the list. The user let's their smartphone photograph the list so that it can know the list too. The user is to keep the list in a safe pace in order to recover the key and obtain access to the CBDC, just in case something might happen to the smartphone. This improves on the familiar safeguarding of banknotes against loss, because the backup key can be copied and need not leave its safe storage.

Such lists are already typical of cryptocurrency hardware wallets popular for storing such currency. Also typical of such wallets is that the user is prompted, by display of a few line numbers, to reveal the words on those lines during a check, to ensure that they really have been written down correctly.

At the commercial bank branch, the user could similarly be asked by the banker to produce the words written on a few of the line. You would be running an app on your phone that communicates the words to the bank's system, but each word encrypted. The banker might simply say: “please read me the words on lines 5, 7 and 14. The banker enters the words into the bank's system, such as by voice recognition. The system, by communicating with your phone app, is able to decrypt those words and confirm to the banker that everything is as it should be.

Of course, neither you nor your phone have given enough words to the bank to allow it to get your secrets, in fact nothing about your secret comprised of the words you did not read is revealed. The crucial thing is that in those words you did not read, you have the secret key. The app on your phone knows the words, but it cannot keep you from recording them elsewhere or otherwise ever take that knowledge away from you.

A different approach would allow the smartphone to divide the words up between a number of banks, so that if the user were to somehow loose possession of the paper and all copies of it, the user could get the words by showing identity at those banks. This approach, if used without paper unfortunately makes significant compromises. For one thing, the person is never guaranteed to actually have gotten their keys initially, since everything is handled by phone. Also, to the extent that the number of other banks required is small, the ease with which someone could get enough information to trace all of a user's transactions increases; but to the extent that the number of other banks is large, the easier it becomes to tip off those trying to take control of a user's digital cash.

The spreading of control over digital currency by the user-irrevocably-knows-keys approach introduced here is related to the spreading of power by voting in democracies. Both involve privacy, of voter choice or of who spent which cash, but the connection runs deeper. In voting, voters may wish privacy of their vote, meaning they control who can see how they vote. But society has an interest in a stronger property, called “ballot secrecy,” which is that even if voters want to show others how they voted, they should not be able to. This ballot secrecy property is typically enforced by mandatory physical presence of voters in booths that is visually verified by poll workers and other voters. This thwarts so-called “improper influence” of voters, which includes vote buying and coercion.

Similarly, a user may of course wish to have privacy of where they spend their cash. But society has an interest in users themselves always having the keys needed to spend, recognize, and trace their cash. The techniques presented here allow society to ensure that nobody can improperly usurp any user's access to the keys conferring those abilities.

### Protocol Background

All the cryptography that defines the basic system is shown in FIG. 2 and detailed below. The basic cryptography, which is in simplified form, that is needed to follow the description and figures is introduced in this section.

The CBDC is based on the (well-known) longstanding RSA cryptosystem. In RSA each party, bank or phone, creates their own public key (famously) by multiplying two large primes of its own secret random choice.

The central bank's public key, c, which it formed in this way, is used to certify CBDC in the system. While anyone can raise a number to a counting number power modulo c, only the central bank can raise numbers to fractional powers modulo c. (This is because only the central bank knows the two numbers it multiplied to form its public key modulus.) In practice larger public primes would be used and the cryptographic assumption would be that no adversary can compute fractional powers on images under f without access to information about how c was formed.

Each user will also have a public key that their phone created from the secret words on the written list. A user can move money between CBCD and their accounts at their bank, using their “secret signing account key” derivable from the word list. (This public signing account key will be shown in the figures as RSA modulus uᵢ.) Such digital signatures authenticate ownership of the corresponding account public key, authenticate identity of the user, and provide durable proof of the transfer instruction details and authorization.

What is assumed about the cryptography is that no adversary can compute fractional powers on images under f without access to information about how c was formed. Thus, the bank's signature is only formed on numbers to which f has been applied; if a pair of numbers, x and f(x) is shown it could only have been created by the bank (following the assumption). A pair of numbers that by convention is worth one cent in the system, x|f(x)^{1/3} (mod c), can be verified by anyone simply raising the second number to the power 3 modulo c and checking that the result equals what is obtained by applying the public one-way function f( ) to the first number of the pair, x.

The value of 1¢ is thus assigned public exponent 3 in the RSA system with modulus c. The value of 2¢ is assigned exponent 5, 4¢ exponent 7, 8¢ exponent 11, and so on; each successive power-of-two denomination value is represented by the corresponding next prime number as an exponent, all under modulus c. Thus, 13¢ (13=1+4+8) corresponds to denominations 1, 4 and 8 cents and prime exponents 3, 7, and 11. Since 3·7·11=231, the first time an x is spent, the pair x|f(x)^{1/231} (mod c) is worth 13¢.

Blind signatures are used here to protect user privacy. A user's smartphone can simply “blind” a desired number f(x) by multiplying it by a random number b that it chooses and raises to a denomination power, for example b³ for a 1¢ coin. This blinded value f(x)b³ (mod c) can, for a charge of 1¢, then be signed in blinded form by the central bank, with its unique ability to compute the fractional power ⅓, resulting in {f(x)b³}^{1/3} (mod c). Because exponentiation distributes over multiplication, what the user's phone gets back equals {f(x)}^{1/3}b (mod c). And since the phone knows b, it can unblind simply by dividing b out, leaving the ⅓ power on f(x) and yielding the phone what turns out to be a perfectly unlinkable unblinded 1¢ coin x|f(x)^{1/3}.

This blind signature protocol was invented by David Chaum in 1982 and in the 1990's DigiCash implemented and provided it to commercial banks, such as Deutsche Bank, that deployed it online connected to their customer's current accounts. [see chaum.com/ecash] Efficiency and speed were not an issue then, and consequently would not be today.

### The Protocol

The withdrawal and payment protocols are the only two that reach the central bank, each through a commercial bank as intermediary, as mentioned. At a high level: the withdrawal allows the user's smartphone to obtain fractional powers of blinded random numbers chosen by the phone; and the payment transaction allows the phone to supply unblinded fractional powers in payment to merchants that then forward them on to its commercial bank who then has them validated and cancelled by the central bank. During withdrawal, instead of simply providing a fractional power on a single value, such powers are in effect provided on more than on f( ). This allows the merchant to return change or a refund returned to the user. This is by what is in effect a pre-approved withdrawal that goes through the merchant's commercial bank to the central bank, crucially without allowing linking to the user's account or any other payment.

Three questions have interrelated answers: How easy is it to scale the system to accommodate demand as the number of transactions per second needed grows? How can the system be prevented from becoming unavailable and blocking people from making purchases? What happens if the central bank's secret signing key were to be compromised by whatever means?

Scaleability has to do with the cost of growing processing capacity so that an increasing number of transactions can get through with acceptable time to finality. Since it is software only, overall system cost can be low. Performance is not an issue, since computers of the 1990's were able to handle the transaction speeds and database sizes. The spent coins are stored only until the key set that validated them is changed, such as through a rolling annual schedule. Since transactions are essentially independent of each other, the amount of additional processing power and bandwidth needed grows by the same amount for each additional spend or deposit transaction per second. This additional power is simply achieved by adding more hardware, called partitioning or sharding, and with so-called consistent hashing, hardware additions need not be disruptive. Any underlying database technology can be used, whether conventional or distributed such as via blockchain.

Payments can be urgent, withdrawals less so. Each payment has one or more digital signed “serial numbers” (called x elsewhere here) and so these parts can in principle be checked for “double-spending” by separate portions of the network. No network can withstand unlimited attack. But if the network can be divided into parts, and each part can process some portion of the transactions' serial numbers, then transactions can be routed to the parts that can handle their serial numbers. This provides for a kind of graceful degradation of service, compared to an all or nothing failure, and can take advantage of geographically distributed servers.

Withdrawals may not be extremely urgent, but they can provide the bedrock security against counterfeiting. Withdrawals can be made a matter of record and available to the account owner so that they can recover their money from their private key. But otherwise, this data should be protected doubly, by the commercial bank and the central bank. After double encryption, for instance, it can be backed up on multiple media and locations.

If the central bank signing key(s) should ever be compromised, such as by a quantum computer, physical attack on data center vaults, or perhaps some new algorithm—although perhaps extremely unlikely—the users can very securely be refunded all the money they have not spent. To accomplish this, the user private key can be used to reconstruct the money numbers x and blinding factors b, as mentioned. The user key does this via the pre-image under a cryptographic one-way function of each, as detailed in the appendix. If these one-way-functions are quantum resistant, then the recovery process would also be quantum resistant. The reason is because, if the coin was already spent then x would already be on the double-spent list, and it would be infeasible to find a different set of pre-images for the same withdrawal that form a different money number x.

In order to detect compromise of a central bank key or keys, statistical monitoring of the network can may provide a rather sensitive indicator. Other security provisions, beyond the present scope, are also possible.

Turning first now to FIG. 1A, a combination block, flowchart and cryptographic protocol diagram for an exemplary payment protocol is shown in accordance with the teachings of the present invention. FIG. 1A is an overall view without a plurality of denominations but including mixing, database and blockchain aspects.

Mix networks were disclosed by the present applicant, for example in “Untraceable Electronic Mail, Return Addresses, and Digital Pseudonyms,” published in Communications of the ACM, vol. 24 no. 2, February 1981. A mix network, in one aspect of use, as is known, allows sending “payload” information in a virtually untraceable manner for what is in effect posting online.

An inventive use of a mix network disclosed here is believed to preserve privacy while also addressing the threat of counterfeiting by adversaries with access to quantum computing. In the exemplary use, every coin is formed by a user's device applying a one-way function f and is then, via the bank, forwarded through a mix network to be included in a database of not-yet-spent coins. While there may be resistant homomorphic signing functions that can be used for the blind signatures, the exemplary approach presented is believed at least to have the advantages that the overall system can work efficiently as without quantum resistant functions, but the quantum resistance that is provided can be based on a very wide class of functions, as will be appreciated.

Optionally, the coin can also be published on a blockchain as shown; this it is believed to allow any customer or other interested party to also be able to check that it appears properly on the blockchain. Other uses and advantages of blockchains are believed to result. Since users have formed the information that is placed on the blockchain, it will be understood that they can make suitable provisions so that they can later authenticate ownership of that information. As just one example application of this, the mix payload information posted as cleartext can contain a public key. The economic value on the chain can then, in some examples as will be understood, be moved to another “account” on that blockchain, by an authenticated request. Moreover, other blockchain operations can be performed, such as those involving smart contracts or transfers to other blockchains, such as through Liquifinity.

Because it is believed that there are practical one-way functions that are what is called “quantum resistant,” it is also believed that even quantum computing cannot be used to counterfeit a coin whose validity depends on the showing of a pre-image relative to a posted image, since in terms of the usual notation, the counterfeiter cannot find x from the published f(x). This also means that even if a quantum computer were able to be used to reverse-compute the central bank's private denomination-signing keys from its corresponding public keys, it cannot create corresponding quantum resistant pre-images. Only by somehow inserting false payloads into the mix that are not noticed in random checking by customers, it is believed, could counterfeiters get images in the posted output for which they know the pre-image x. Thus, it is believed that the total amount of economic value outstanding, at least to a first order approximation, becomes a matter of public record on the blockchain(s).

As central banks around the world undertake the development of digital currencies, transaction privacy emerges as a core concern for consumers as well as institutions. The E-Cash 2.0 proposal, based on the “electronic cash” developed by David Chaum in the 1990s, uses a version of Chaum's 1983 blind signature protocol to unlink withdrawals from payments. However, in this CBDC model, the currency is issued by a central bank, while commercial banks distribute it via customer accounts, conducting “inalienable” authentication of users via a novel public-private key protocol which allows for compliance with existing KYC-AML regulations. This protocol gives users the ability to identify payees, forestalling aggregation for criminal purposes.

The following numbered paragraphs describe various embodiments of the invention
1) A combined physical and cryptographic protocol for establishing by a first party to at least a second party that at least a person has at least physical access to a secret aspect related to a public aspect, comprised of:
   providing by the first party to the second party of at least a commitment to at least a secret aspect of at least a related public aspect;
   a cryptographic protocol at least by the first party establishing to the at least second party that the committed secret aspect corresponds to the public aspect;
   the person revealing portions of physical indicia information to the second party responsive to requests by the second party, where which portions are requested by the second party is at least partly outside the control of the person and the first party;
   a cryptographic protocol establishing at least to the second party that the revealed portions of physical indicia information correspond to the commitments to the private aspect and to the public aspect; and
   so that the second party has been provided evidence, at least with an acceptable probability, that more of the physical indicia can be used to substantially reconstruct the private aspect.
2. In the protocol of 1, the revealing of physical indicia information including revealing portions of physical indicia.
3. In the protocol of 1, the revealing of physical indicia information including reading by the person of portions of physical indicia.
4. In the protocol of 1, where the public aspects are public keys and the public keys are used to commit to blinding factors during a protocol that delivers cryptographic data having value in subsequent transactions.
5. In the protocol of 2, where the public aspects are public keys and the public keys are used to commit to money numbers during a protocol that delivers cryptographic data having value in subsequent transactions.
6. In the protocol of 3, where the public aspects are public keys and the public keys are used to commit to values for which pre-images under at least one one-way function of at least almost all of the inputs are shown, in a protocol that delivers cryptographic data having value in subsequent transactions, such that when a refund is requested the values are known with at least acceptable probability to have pre-images that were known to the submitting party.
7. In the protocol of 1, where the public aspects are images under cryptographic one-way functions and the private aspects are related cryptographic data sufficient to transfer value related to the images under the cryptographic one-way functions in subsequent transactions.
8. In the protocol of 2, where the public aspects are images under cryptographic one-way functions and the private aspects are related cryptographic data sufficient to transfer value related to the images under the cryptographic one-way functions in subsequent transactions.
9. In the protocol of 3, where the public aspects are images under cryptographic one-way functions and the private aspects are related cryptographic data sufficient to transfer value related to the images under the cryptographic one-way functions in subsequent transactions.
10. In a cryptographic protocol for digital currency between a first bank and at least a second bank and at least one merchant and at least one user, where the at least second bank conducts authentication of the at least one user based on at least a user private key and the at least one user is able to withdraw from the at least first bank and anonymously pay at the at least one merchant, the improvement comprising:
   the at least one user being able to identify the money withdrawn under its authentication when it is paid at a merchant and presented to the first bank, even if the user interaction with the merchant is later simulated by those who gain access to the user private key.
11. In a cryptographic protocol for digital currency between a first bank and at least a second bank and at least one merchant and at least one user, where the at least second bank conducts authentication of the at least one user based on at least a user private key and the at least one user is able to withdraw from the at least one second bank and anonymously pay at the at least one merchant, the improvement comprising:
   the at least one user being able to spend the money withdrawn under its authentication if the at least one user spends it before any other party that may gain access to the secret values used to spend the money.
12) In the cryptographic protocol for digital currency of one of 10 or 11, including:
   providing change from the amount spent by the user resulting from plural merchant payments;
   depositing the change at the at least one bank by the user; and
   such that patterns of any denominations used in obtaining change by the user from the merchant interactions are at least partially hidden from the first bank and at least a second bank of the merchant.
13. In the protocol of 10 or 11, including:
   a cryptographic subprotocol establishing that a revealed physical list of indicia can substantially be used to reconstruct at least a private aspect of at least a committed public aspect of the key;
   the person revealing requested indicia portions to the second party, where which portions are requested is at least partly outside the control of the person and the first party; and
   the second party receiving cryptographic evidence that the revealed portions of the indicia at least with substantial probability correspond to the respective entries on the physical list of indicia.
14) In a blind-signature cryptographic protocol for digital currency between at least an issuer and at least one user, including:
   the user computing a blinding value as an image under a substantially one-way function of a substantially random pre-image value known to that user;
   the user transforming the blinding value into a blinding factor by a publicly available transformation;
   the user combining the blinding factor with at least an image under a one-way function of a payload value;
   the user supplying the blinded payload to the issuer for withdrawal;
   the issuer forming a signature on the blinded payload value with a key that imparts value to the payload;
   the issuer checking these pre-images by applying the one-way functions and public blinding functions, at least with some probability before providing for the return of value.
15) In a protocol for establishing between a user first party, along with a user computer, and a second party, that the user has access to a cryptographic key for which the second party learns at least some public information, including:
   the user first party providing the words to the user computer;
   the user computer providing cryptographic commitments to the second party related to the words;
   the user first party demonstrating possession of a written list of words at least including by providing some of those words, responsive to inquiries from the second party, to the second party;
   the user computer opening to the second party at least some aspects of at least some of the supplied commitments related to the words chosen; and
   such that the second party being convinced by cryptographic protocols that private information related to the at least public information is obtainable by the user first party from the words not provided to the second party.
16. In a cryptographic protocol where resistance against diversion is wanted, a party having a secret key forming a related public key and the information provided to at least a second party being encrypted with that public key, and the third party maintaining the information in the form of the encryption provided it; and the third party providing the information in the form of the encryption provided it from the first party back to the first party at a later time; and such that the first party can recover the information provided by the first party to the second party.
17. A method between at least one person and at least one device and at least one additional entity, including:
   the at least one person having secret information, the secret information at least substantially unknown to the at least one additional entity;
   the at least one device providing confirming information to the at least one additional entity;
   the at least one person providing filtered information to the at least one additional entity;
   the filtered information substantially recognizable by the at least one person as corresponding to the secret information;
   the at least one additional entity witnessing the at least one person demonstrating at least substantial access to at least the filtered information;
   so that the at least one additional entity enabled to at least substantially verify that the filtered information received at least related to the confirming information received; and
   so that the at least one additional entity at least able to substantially verify that, at least with a substantially acceptable probability, the confirming information substantially related to the secret information.
18. In the method of 17, including the confirming information at least corresponding to cryptographic public key information.
19. In the method of 17, including the at least one person answering queries about the secret information and the queries and their respective answers substantially at least corresponding to the filtered information.
20. In the method of 17, including the at least one additional entity provided viewing of the at least one person obtaining the filtered information from a physical record distinct from the at least one device; and so that the at least one additional entity blocked from viewing the secret information.
21. In the method of 17, including the secret information at least in part created by the at least one person.
22. In the method of 17, including the secret information at least in part created by the at least one device.
23. In the method of 17, including the selection of the filtered information determined at least in part by information mutually random to at least one of the at least one device and at least one other entity.
24. In the method of 17, including at least one query selected by the at least one additional entity provided to the at least one person.
25. In the method of 17, including at least one query selected from a set and the selection at least in part by a value that is substantially mutually random to the at least one device and to the at least one additional entity.
26. In the method of 17, including at least two filtered information alternatives supplied by the at least one device to the at least one additional entity.
27. In the method of 17, including verification by the at least one additional entity of at least substantially a cryptographic proof from the at least one device.
28. In the method of 17, including the at least one device providing the at least one additional entity with at least a sequence of cryptographically hidden symbol values.
29. In the method of 17, including the at least one device providing the at least one additional entity a cryptographic proof that the hidden symbol values combine to a private key value corresponding to public key information corresponding to the confirming information.
30. In the method of 17, including the at least one device providing the at least one additional entity substantially a cryptographic proof that at least a particular supplied predicate applies to at least a portion of the hidden symbol information.
31. In the method of 17, including the at least one device able to receive at least one query by the at least one additional entity; and if the query violates constraints knowable at least to the at least one additional entity, then the at least one device able to provide the at least one person with an alarm signal.
32. In a cryptographic protocol for value transfer including at least a withdrawer party and a signing party, comprising:
   performing a withdrawal instance of a private payment protocol;
   withdrawer forming a payload related to the withdrawal instance;
   payload formed by withdrawer sent through untraceability means;
   so that the sending of the payload through the untraceability means subject to limitation by at least a party apart from the withdrawer;
   so that the payload output by the untraceability means validates substantially a single payment authenticator; and
   so that the payment authenticator is substantially difficult to derive from the payload.
33. The cryptographic protocol for value transfer of 32, comprising: so that the difficulty of deriving the payment authenticator from the payload at least includes inverting an at least substantially one-way function.
34. The method of 33, comprising the one-way function being quantum resistant.
35. The cryptographic protocol for value transfer of 32 or 33, comprising: a transfer of value authenticated relative to the payload controlled by a second authenticator at least at a future time.
36 The cryptographic protocol for value transfer of 32, 33, or 34, comprising: the payload indicating a selection among plural cases;
   where a first case includes that the value to be transferred off chain; and
   where a second case includes that the value to be transferred on-chain under control of a second authenticator.
37. The cryptographic protocol for value transfer of 32, 33, 34, or 35, comprising: the private payment protocol including at least a blind signature aspect so as to protect payer privacy.
38. In a cryptographic method conducted between a person, a device of the person, and at least an additional entity, the steps of:
   establishing secret information by the device of the person and the person, and the information substantially secret from the at least one additional entity;
   communicating at least a cryptographic commitment and cryptographic public key information from the device of the person so that it can be received by at least the additional entity;
   the person answering queries related to the secret information so that the at least one additional entity can obtain the answers from the person;
   so that the device of the person substantially convincing the at least one additional entity that the answers provided are at least consistent with the secret information known to the person and the commitment and the public key information; and
   so that the at least the one additional entity substantially convinced by the person and the device of the person, at least with acceptable probability, that the private key information is readily computed from the secret information known to the person.
39. In a cryptographic method conducted between a person, a device of the person, and at least an additional entity, the steps of:
   at least one person at least having secret information;
   the secret information at least substantially known to at least a first device;
   the secret information at least substantially unknown to at least a second device;
   the first device providing public key information to the second device;
   the second device providing query information to the at least one person;
   the at least one person providing answer information to the second device; and
   so that the at least second device enabled to learn, at least with a significantly acceptable probability, that the secret information allows substantially ready computation of the private key information related to the public key information.
40. The cryptographic protocol of 39, comprising: plural queries and plural responsive answers.
41. The cryptographic protocol of 39 or 40, comprising: at least one subsidiary device with access to a least an aspect of the secret information that is secret from the first device; and the at least one subsidiary device providing information to the at least one first device cooperating in proving that the secret information allows substantially ready computation of the private key information related to the public key information.
42. In a cryptographic proof system, proving possession of a confidential private key for a respective public key, including:
   providing a cryptographic proof of knowledge of each symbol separately.
43. In the system of 42,
   the public key comprised of the product of multiple blinded symbols;
   the respective private key symbols being raised to a blinding power to form the blinded symbols; and
   proving that each blinded symbol contains at most a determined number of substantial generator elements.
44. In the system of 42 or 43, showing that the private key corresponding to one public key can readily be computed from the private key of a second public key, comprising:
   showing that all but a substantially small number of the respective digits of each of the two private keys are identical.
45. In a cryptographic protocol between each of a plurality of users and at least one entity, comprising: the at least one entity establishing at least one public key for a user, so that the user can reconstruct the corresponding private key from a passphrase substantially witnessed by the at least one entity as known to the user.
46. The protocol of 45, comprising: the at least one entity providing a signature on at least one established public key, so that the respective user is able to transform that signature into a signature on another public key of that same user with a second of the at least one entity.
47. The protocol of 45, comprising: a second of the at least one entity being able to verify evidence provided by a user that a second public key can be reconstructed by the user that formed the first public key.
48. The protocol of 47, comprising: the components of the second public key are a particular known function of the components of the first public key.
49. The protocol of 45, comprising: at least a second of the at least one entity providing for the user suppling cryptographically hidden instances of protocol values that are selectively opened and where that entity is provided verifiable evidence that public key is properly formed.
50. The protocol of 45, comprising: at least one entity providing for a user supplying cryptographically hidden instances of protocol values for which interrelationships are demonstrated to the entity so that verifiable evidence is provided that at least one of the private keys corresponding to the two public keys can be computed by someone who knows how to compute the private keys corresponding to the other one of the public keys.
51. The protocol of 45, comprising: at least one entity providing for a user supplying cryptographically hidden instances of protocol values for which interrelationships are demonstrated so that the entity is provided verifiable evidence that at least the public key that can be computed from the other public key is unique.
52. A payment system including an issuer and at least one customer and at least one payee and at least an untraceable-sending system, comprising:
   the customer providing at least an untraceable payload message with a withdrawal request to the issuer;
   the issuer forwarding the untraceable payload message to the untraceable sending system;
   the payload exiting the untraceable sending system being recorded; and
   so that information linking withdrawals to recorded payloads at least to some extent hidden.
53. In the payment system of 52, comprising: the issuer providing a signature on a blinded item supplied by the payer; and the payer supplying the signed unblinded item in payment.
54. In the payment system of 52, comprising: checking the payment including the signature on the image; and checking the payment including computing the image from the pre-image and atomically checking and removing the image from the record.
55. In the payment system of 54, comprising: the image being quantum-resistant to decryption to the pre-image.
56. In the payment system of 52, comprising: the payload including authentication information used by the payer to change ownership of information associated with the payload.
57. In the payment system of 53, comprising including a blinded form of a secondary image in the blinded form of the primary image signed blind by the issuer; convincing the issuer that the two pre-images are related; and so that the issuer can return a signature on the secondary image when the primary image is not used in payment.
58. An inalienable key establishing, comprising:
   at least one person having secret information, the secret information at least substantially unknown to at least one additional entity;
   at least one contributing party providing contributing information, responsive to the secret information in hidden form, to at least one device of the person;
   the at least one device of the person providing commitment information to the at least one additional entity;
   the commitment information including at least the secret information in hidden form and the contributing information in hidden form;
   the at least one person providing answers to queries to the at least one additional entity;
   the at least one additional entity witnessing the at least one person demonstrating at least some access to at least the secret information by answering the queries;
   so that the at least one additional entity enabled to at least substantially verify that, at least with a significantly acceptable probability, the commitment information is at least consistent with the public key information; and
   so that the at least one additional entity enabled to at least substantially verify that, at least with a significantly acceptable probability, the answers received to the queries are at least consistent with the commitment information.
59. In the inalienable key establishing of 58, comprising: so that the at least one additional entity enabled to at least substantially verify that, at least with a significantly acceptable probability, the contributed information is at least consistent with the secret information.

### BRIEF DESCRIPTION OF THE DRAWINGS

FIG. 1A illustrates a diagram showing a blind signature payment protocol.

FIG. 1B illustrates a schematic, block, and cryptographic protocol diagram for an exemplary withdrawal and payment protocol.

FIG. 2 illustrates a combination cryptographic and physical protocol for validating that a user can have access to a key.

FIG. 3 illustrates an alternative combination cryptographic and physical protocol for validating that a user can have access to a key.

FIG. 4A illustrates a combination block and cryptographic protocol and view-blocking-arrangement diagram.

FIG. 4B illustrates a message exchange protocol ladder diagram.

FIG. 5A illustrates flowcharts of the proof of human knowledge of private key protocols.

FIG. 5B includes exemplary aspects of the overall process of FIG. 5A.

FIG. 6 illustrates exemplary flowcharts of the proof of human knowledge of private key protocols.

FIG. 7 illustrates a combination flow and cryptographic diagram for an exemplary embodiment of a value transfer system, including privacy and quantum-resistant aspects.

FIG. 8A illustrates a combination flow chart and cryptographic protocol of an overall withdrawal protocol.

FIG. 8B illustrates an additional step for the protocol of FIG. 8A involving quantum security against counterfeiting.

FIG. 8C illustrates an additional step for the protocol of FIG. 8A-8B, including a transfer on a blockchain/ledger of the value.

FIG. 8D illustrates an additional step for the protocol of FIG. 8A-8C, including recording on the blockchain/ledger the type of further transfer.

FIG. 8E illustrates an additional step for the protocol of FIG. 8A-8D, including the use of a blind signature payment system.

FIG. 9A illustrates combination block and cryptographic protocol diagrams and flowcharts for private key computability proofs, the protocol for convincing that two public keys have private keys that can readily be computed from each other.

FIG. 9B illustrates a protocol for convincing that two public keys, one provided to one party only in blinded form, have private keys that can readily be computed from each other.

FIG. 9C illustrates a protocol for convincing that three public keys, one provided to one party only in blinded form and another provided in signed blinded form, have private keys that can readily be computed from each other.

FIG. 9D illustrates a flowchart detailing the three protocols and including the return of signed blinded public keys in the second and third protocols.

FIG. 10A illustrates combination block and cryptographic protocol diagrams that shows the blocks in an arrangement for the protocol.

FIG. 10B illustrates a message exchange protocol ladder diagram.

FIG. 10C illustrates multiple constituents cooperating with a single device.

FIG. 11A illustrates combination block-diagram and flowcharts for a cryptographic protocol and view-blocking-arrangement as a general case.

FIG. 11B illustrates additional steps for the arrangement of FIG. 11A. exemplary additions and variations.

FIG. 12A illustrates a combination flowchart cryptographic protocol diagram of a symbol commitment and proof system with proofs that the encrypted symbols are each properly formed.

FIG. 12B is an example proof that a particular symbol sequence position has the same symbol as a second particular symbol sequence position.

FIG. 13 illustrates a detailed exemplary cut and choose cryptographic protocol diagram for establishing an inalienable public key.

FIG. 14 illustrates a combination flowchart and block diagram of an exemplary inalienable credential mechanism.

FIG. 15A illustrates a combination flowchart and block diagram of a cryptographic protocol for value transfer, including a value transfer system generally involving an untraceable sending to recordation.

FIG. 15B illustrates the system including a blind signature protocol.

FIG. 15C illustrates the atomic checking for the presence of an image before accepting a transfer.

FIG. 15D illustrates a quantum-resistant formation of the image.

FIG. 15E illustrates the transfer of the value based on the recorded authentication information.

FIG. 15F illustrates the inclusion of authentication of a secondary image within a primary image.

FIG. 16A illustrates an overall combination cryptographic diagram, block diagram, plan view, and ladder diagram, for inalienable key establishing with repeatable contribution with FIG. 16A being similar to FIG. 4A, apart from the elements called out with numerals beginning with sixteen instead of four.

FIG. 16B includes and elaborates on those new elements and also includes them in the proof.

FIG. 17 illustrates an overall flowchart and process steps for inalienable key establishing with optional repeatable contribution

FIG. 18 illustrates an architecture diagram of the inventive system.

FIG. 19 illustrates a withdrawal protocol for the inventive system.

FIG. 20 illustrates a payment protocol for the inventive system.

FIG. 21 illustrates a flow diagram relating to a transaction that involves change.

FIG. 22 illustrates a flow diagram relating to a zero knowledge proof.

### DETAILED DESCRIPTION OF THE INVENTION

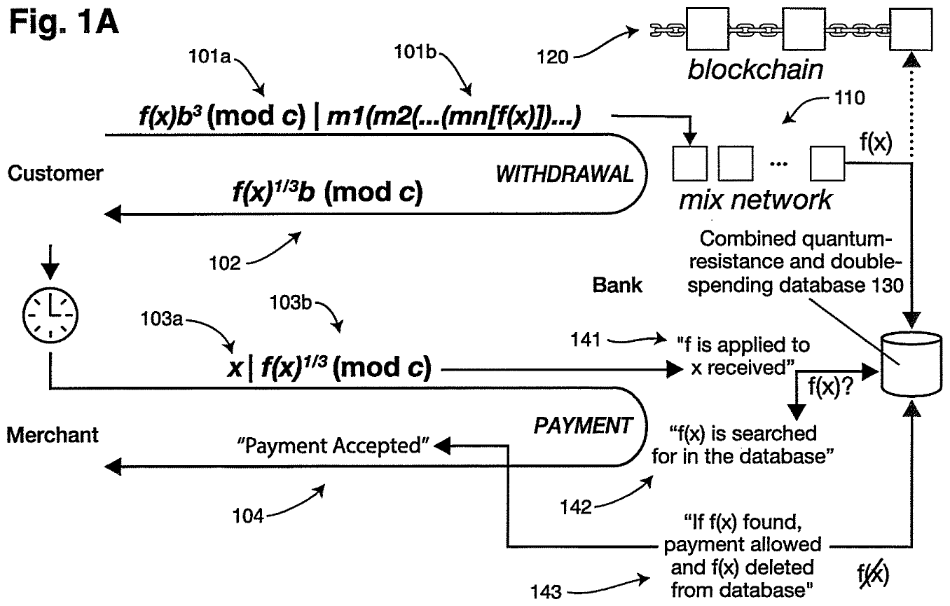

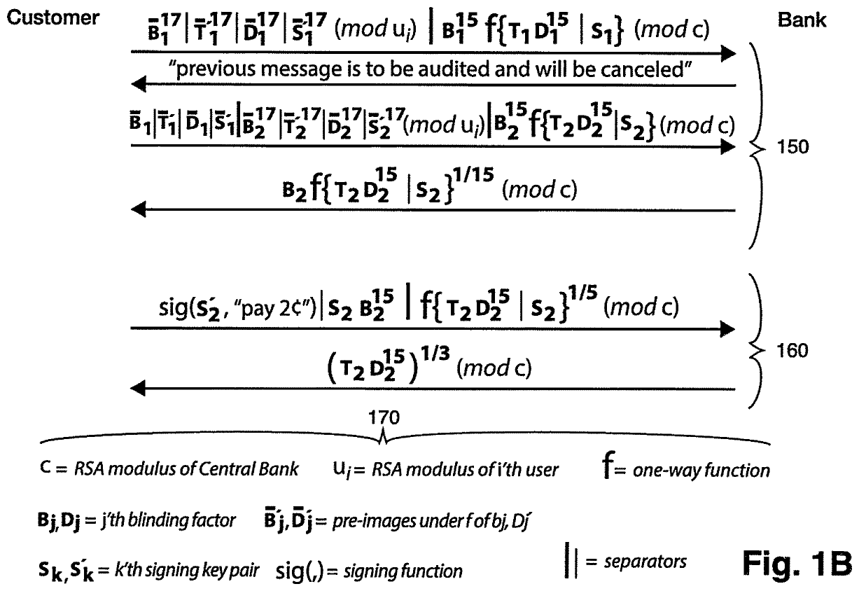

Referring now more specifically to FIG. 1A, shown are the known elements and/or steps of a blind signature payment protocol, such as disclosed by the present applicant in U.S. Pat. No. 4,759,063 “Blind signature systems”: blinded withdrawal 101a; signed blinded values returned 102; the unblinded but signed coin being used in payment 103a-b; and the acknowledgement from the bank 104 that the payment was accepted. In known such systems, the value of x can be stored in the database once the coin is spent to prevent what the present applicant called “double spending”; in contrast, in accordance with examples of the present invention, the value of f(x) is stored during withdrawal and the payment rejected if it cannot be reconstructed from the pre-image supplied.

Also believed novel, compared to prior art blind signature payment protocols, is what is achieved by the second component of the withdrawal transaction, m1(m2( . . . (mn[f(x)]) . . . ). This value is shown being allowed as input to the mix network 120 by the bank, with the payload output of the mix network, f(x), going into the “combined quantum-resistance and double-spending database” 130, to be described further. The public keys, m1, m2, . . . , mn, are the public keys of the respective mix nodes, with m1 corresponding to the so-called “entry node” or first node of the so-called “cascade” of mix nodes and mn to the so-called “exit node” or last node of the cascade.

Also shown is that f(x), optionally as indicated by the dotted line, is recorded on a blockchain 120. In some examples there may be more than one blockchain and individual images f(x) can be recorded on multiple such blockchains or the particular corresponding blockchain can be selected by indication information in the payload.

In operation, and in brief summary, the payload contained in the second component of the withdrawal 101b is recorded in the combined database 130, but which withdrawal it corresponds to is hidden by the mixing 110. This is done as is known by each “node” successively striping off the respective layer of encryption (shown in 101b) using its private keys and randomly permuting the batch of items before sending on to the next mix node in the mix. Thus, when a payment is received by the central bank 103a-b, as in known blind signature payments, the additional difference is believed that the central bank looks in the combined database: if the image under f that it reconstructs 141 from x in message 103a received, f(x), is already in the database 142, then the payment is allowed and that image, in the same atomic operation of finding it, is removed 143 from the database 130. But because of the mixing 110, which withdrawal corresponds to the payment is not revealed.

Turning now to FIG. 1B, a combination overall schematic, block, and cryptographic protocol diagram for an exemplary withdrawal and payment protocol is shown in accordance with the teachings of the present invention. The figure includes a plurality of denominations, in contrast to FIG. 1A already described, but does not show some mixing and database and blockchain aspects.

The withdrawal 150 protocol and payment protocol 160 are shown in the conventional arrow diagram notation, as will be understood, with the user or customer on the left column and bank on the right. Some aspects of the notation are also described for convenience in the drawing key 170.

This protocol differs from the protocol underlying it that was described above with reference to FIG. 1A in two aspects. The first is that in this example everything submitted in a withdrawal can either be accepted by the bank or randomly audited. This is believed to allow the bank to ensure, at least with high probability, to ensure that what it signs can be used in payment by the account holder's inalienable private key. Other types of proofs of these properties are anticipated here and can readily conceived by those of skill in the art; however, the present technique has been selected for concreteness and clarity in description, as will be appreciated. The second difference is that during withdrawal, in addition to the user submitting each blinded value, the user also submits another set of blinded values, each paired with a corresponding first blinded value submitted. In this way, it is believed, the bank can, if needed during a payment, sign to securely return a withdrawn but unspent denomination image to the customer. The reason is that it is believed the two coins share the same pre-image in the database and that only one is spent.

An additional difference is that instead of an unpredictable or “random” group pre-image x being the coin, the user creates a distinct public key to serve as the pre-image for each distinct image. This public key is shown where x was in the previous protocol; the private key corresponding to this public key is kept secret by the user that created it. The types of messages signed with the public key can be random with suitable redundancy and/or they can for instance include information related to the payment, such as invoice or order information. This signature in effect serves like the pre-image for x. Although the withdrawal example shows only 1¢ and 2¢ coin values (since showing a larger number or range explicitly becomes unwieldy, as will be appreciated), the approach naturally extends to any number of denominations, such as encoded by small distinct primes, as will be understood.

Referring now more specifically to the figure, the upper four arrows show an example withdrawal 150 and the lower two make up a simple example payment transaction 160 that includes a returned value. The example withdrawal, simplified to just two denominations, as already mentioned, comprises two main parts, as shown on the upper line. The first part is a list of all the pre-images for the second part. These pre-images are indicated with a bar above them (as detailed in the diagram's key 170, shown below the messages). They also have a power of seventeen on them, modulo uᵢ, to indicate encryption with the user's public key to hide them from the bank. This encryption, however, is using the customer's inalienable public key uᵢ and therefore is believed ensured of being decryptable using the customer's passphrase. If these pre-images are chosen for audit, as in the example shown, then the customer is to decrypt them, and then the bank should it is believed be able to check that it can use them to reconstruct everything in the second portion of the message.

This audit is by means of what the present applicant has called a “cut-and-choose” protocol, used here for simplicity instead of a more elaborate type of proof for clarity as mentioned. In operation, it proceeds as follows: some instances are first provided by the customer to the bank in encrypted form; the bank then randomly chooses some of these instances to be requested to be supplied by the customer in decrypted form; these decrypted values are checked upon receipt by the bank as having been formed according to the prescribed protocol; and a level of confidence that the unopened instances have been correctly formed is believed obtained by the bank.

For clarity in the diagram, a single coin withdrawal is shown as either accepted or audited. The first coin (with subscript 1) is shown as audited, and the second attempt (subscript 2) as not audited but signed and returned, as will be understood.

The signed coin returned is shown blinded with b₂. It contains an image under f of two components. The first component is a blinded coin T₂. The second is a coin S₂. The bank's signature on this pair, with the 1/15 power, makes S₂ worth 3¢, by the example convention of lexicographically mapping the odd primes to the binary denominations, as is known and as will be understood. But in the subsequent example payment transaction 160, only the 2¢ power is revealed by the payer. Thus the 1¢ power it is believed should be returned by the bank as unspent. This is accomplished by the bank signing the first component within f, the blinded T₂, applying the ⅓ power that makes it worth 1¢. Even though the bank may not know who created the blinded value it is signing with the change value, it is believed that it knows that the cryptographic form was audited during some customer withdrawal and so must be un-blindable using that customer's inalienable private key.

Extending to more than two denominations, as is known in the prior-art blind signature payment protocols, entails standardizing a distinct prime public exponent for each denomination, as mentioned. It is believed that any combination of such exponents multiplied together in the exponent allows algebraic separation of the signatures. Thus, a coin that has a full complement of denomination signatures, one for each denomination, can, it is believed, be used to pay for any amount up to the sum of all its denominations, just by separating the denominations not used. But then the signature for the amount that should be returned to the payer, corresponding to the unspent denominations, can be applied by the bank to the “pre-approved” blinded coin T. For example, it is believed that the customer can cryptographically rearrange a signature with sixteen denominations to reveal only enough to pay any amount up to $655.36 with exact cents, and then the difference between $655.36 and the amount paid can be returned in the form of the corresponding denominations on the blinded T portion.

A well-stocked wallet, made up of coins each with such a complete complement of denominations, is believed to ensure that the user can make one payment for each such coin, with all the unspent value will be returned as new signatures. Even a messy wallet with various returned signatures in it, will sometimes have enough coins for the exact amount of payment. But instead of taking the chance (or having to pay a slightly different amount) when there are no complete coins, the user can communicate with the bank and refresh the denominations. It is believed that a messy wallet can be cleaned up by a payment to the bank combined with a fresh withdrawal. To reduce what might be revealed during such a refresh, an untraceable communication system can be used and the number of payments between refreshes can be increased; and also various balances can be kept from refreshes.

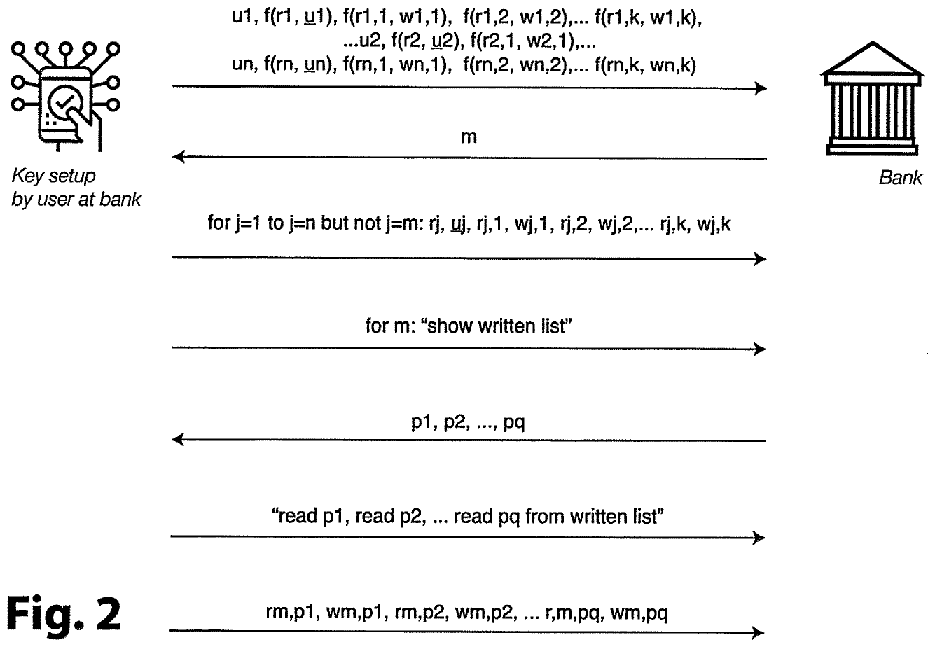

Since only one of a coin and its corresponding paired coin will be spent, as mentioned, it is believed that they can share the same quantum-resistant pre-image public key. Turning now to FIG. 2, a detailed combination cryptographic and physical protocol is presented for validating that a user can have access to a key, in accordance with aspects of the present invention. The parties shown are the user smartphone or the like and the bank system or the like, for clarity.

First a collection of images under f are sent by the smartphone to the bank in establishing an account public key ui, for user i, as already mentioned. For clarity and concreteness in this diagram, as will be appreciated, the user number portion of the indexing is omitted. Accordingly, there are n public key candidates provided, u1, . . . , un. For the jth public key, j between 1 and n, there are k words the user should write down and they are denoted wj,1, . . . 1j,k. The values are each sent in an encrypted or committed form; in the example notation for clarity the cryptographic function fis used, and it can be assumed here to be essentially bijective and thus provide a strong commitment. When a value is sent, a random key is used to hid it as a second pre-image to f, as will be understood. The random values for the private keys, u1 to un are, respectively, r1, . . . , rn. The random values for the words, w1,1 to wn,k are, respectively, r1,1, . . . , rn,k.

The next step shows the bank providing an unpredictable choice between 1 and n, denoted m. A single choice is provided, however, multiple choices and proofs of the relationship between the items not chosen are also anticipated, as are well known.

The smartphone opens all the previously sent commitments, just mentioned, except it does not open any of those that correspond to m. This step could be in parts or at various times.

The user is indicated next somehow showing the written list of words for m. This can be written, for instance, by the user on a piece of paper in advance or at the bank and then shown, best in a way that does not reveal all the words to the bank. The list could, for instance, be protected by a sleeve with scratch-off or other selectively removable covering, so that portions can be revealed without revealing other portions.

The bank provides some indices to items on the list of indicia, in the example shown as p1, p2, . . . , pq. These are selected at least without control by the person, in some examples randomly or mutually randomly. They could be chosen by physical experiment, such using dice.

Responsive to the bank choices, the user reads and/or shows the selected indicia to the bank.

Also, the smartphone provides the keys for each individual indicia that is revealed, so that the bank can check the commitments sent earlier and verify that they did include the indicia. The keys hiding the values in the f's are sent: rm,p1, . . . r,mpq. For concreteness, the indicia to open the commitments are also shown sent electronically: wm,p1, . . . wm,pq.

Turning now to FIG. 3, an alternate detailed combination cryptographic and physical protocol is presented for validating that a user can have access to a key, in accordance with aspects of the present invention. The parties shown are the user smartphone or the like and the bank system or the like, for clarity.

User writes down list of words chosen ideally independently and uniformly from, for instance, a dictionary or an online list of 2048 words.

For the ith word, word(i), 1≤i≤m, the phone computes commit(i)=g\hat{ }f(word(i))·h\hat{ }f(random)i)), where all non-index values are assumed but not explicitly shown as modulo a large prime p for which discrete log is hard, g and h are generators modulo p,f is a cryptographic one-way function with domain and range modulo p, and the random(i) are chosen independently and uniformly at random by the user phone.

For all j that the bank chooses from among the values assumed by i(1≤i≤m, but i=j n times and i≠j m−n times, e.g., m=24, n=12): user shows to bank that word(j) is on the written list; and phone sends random(j) to bank.

Bank tests that for all n values of j it chose: commit(j)=g\hat{ }f(word(j))·h\hat{ }f(random (j)).

Phone sends to bank, for all m−n values of k,(1≤k≤m, k≠j), where k takes exactly those values of i not taken by j:

$$\begin{matrix}D = h \hat{} [ d = f ( random ( {k}_{1} ) ) + f ( random ( {k}_{2} ) ) + … + f ( random ( {k}_{m} ) ) ] ; and \\ C = g \hat{} [ c = f ( word ( {k}_{1} ) ) + f ( word ( {k}_{2} ) ) + … + f ( word ( {k}_{m} ) ) ] .\end{matrix}$$

Bank checks: D·C?≡? (commit(k₁)·commit(k₂)· . . . ·commit(kₘ)).

Bank then issues challenges: g^{z}, h^{y}.

Phone responds to challenges with: D^{y}≡h^{y}\hat{ }d and C^{z}≡g^{z}\hat{ }c.

Bank checks responses D^{y} and C^{z} by applying y and z.

The user public key is then C.

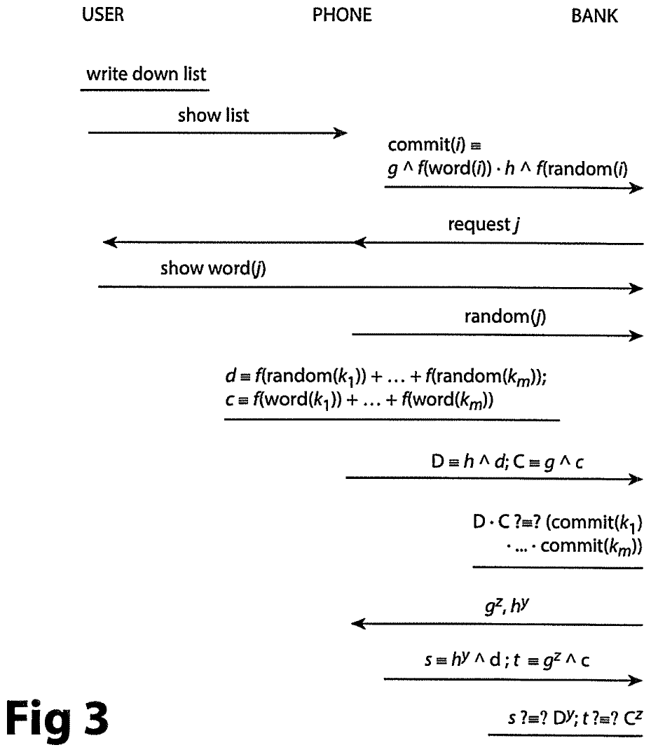

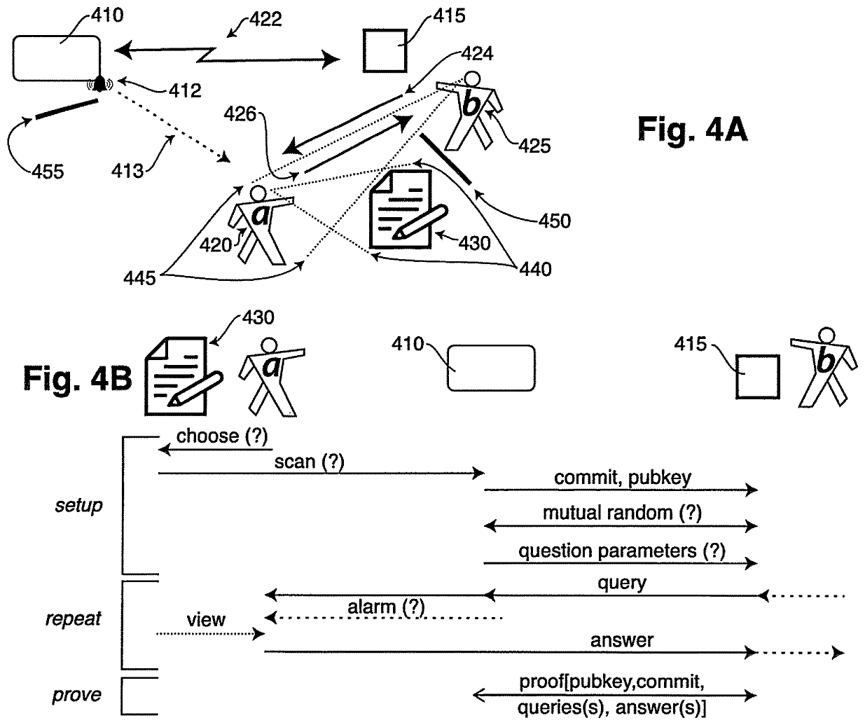

Turning now to FIGS. 4A and 4B, a detailed combination block and cryptographic protocol and view-blocking-arrangement diagram are shown in accordance with the teaching of the invention. FIG. 4A shows the blocks in an arrangement for the protocol; FIG. 4B shows the message exchange protocol ladder diagram.

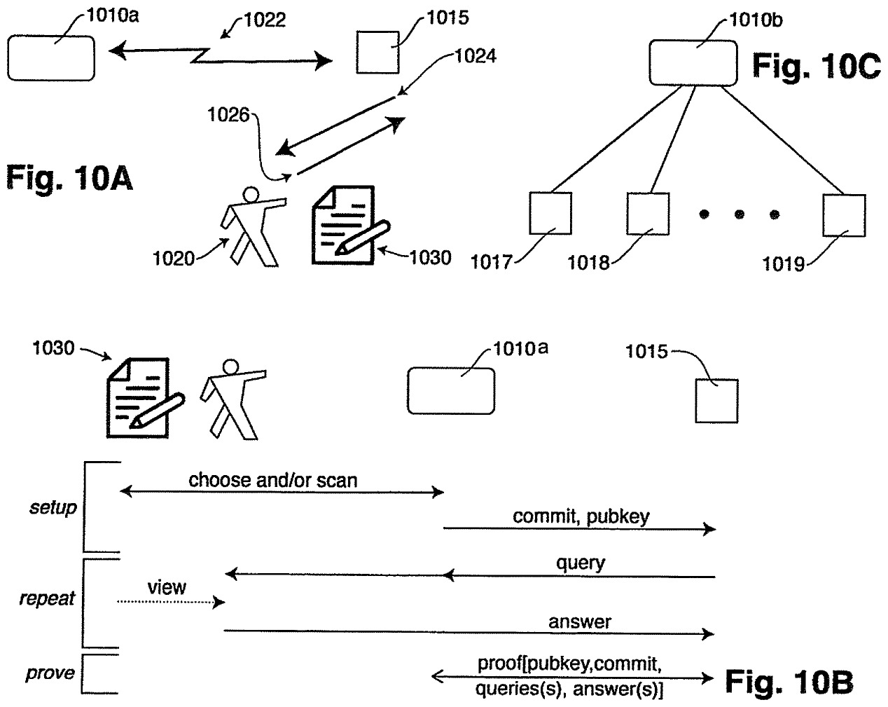

Referring more specifically now to FIG. 4A, on the “person” “a” side, a smartphone or other digital device 410, typically owned and/or used by the person, which can be one of plural such devices, such as including for instance a smart watch, is shown. A second device 415, on the “additional entity” “b” side, is shown as a square, and can be one or more computers and/or networked devices (as will further be elaborated, for clarity, with reference to FIG. 10A-C). Bidirectional communication link 422, for communication at least between devices 410 and 415, such as for instance over bluetooth and/or Wi-Fi or other wireless and/or optical/IR and/or wired communication means with whatever cryptographic and/or quantum security, as may be known, is shown as a lightning arrow.

The example person “a,” which can in some optional examples be more than one person, such as in the case of joint custody accounts for instance, as will be understood, is shown being able at least to visually see media 430. The example counterparty, that may here be called “at least one additional entity,” is zero, one, or more persons 425 in combination with associated devices 415.

The dotted lines are intended to indicate what is visible to the respective persons or devices. Lines 440 indicate that person 420 can see what can be called “paper,” “form,” and/or “media” 430; and lines 445 that person 425 (and devices located near person 425) can see person 420 viewing paper 430. However, privacy shield 450 is intended to what can here be called “hide” and/or “block” and/or “obscure from view” the actual secret passphrase or other symbols on the medium 430 from view and/or reading by person 420 such as can have been written by person 420, from view by person 425. Similarly, shield 455 can be said to “hide” and/or “block” and/or “obscure from view” the device 410 and/or at least information that can be displayed by the device 410, from view and/or reading by person 420. (All manner of optical technologies, including ground glass as well as filtering by wavelength and polarization type are anticipated for hiding, blocking, and/or obscuring from view.) The presence of the shield 450, already mentioned, is believed in the interest of person 420, as it helps keep person 425—and also associated device(s) 415—from obtaining the secrets from media 430; similarly, shield 455 is believed in the interest of the additional entity, such as including device 415 and person 425, by ensuring that person 420 does not answer the queries by consulting device 410 but rather answers from memory or by viewing and/or otherwise using medium 430.

Solid line arrow 424 indicates what may here be called “queries” and/or “questions” or the like being provided by the counterparty and/or for instance by person 425, in the example, to person 420; similarly, solid line arrow 426 indicates what may here be called “answers” and/or “responses” provided, for instance responsively, by person 420 to the counterparty generally and/or for instance person 425.

In some examples, device 410 optionally includes an “alarm” signaling means and/or method, shown schematically as a bell icon 412. When present, an alarm signal can be delivered by device 410 to person 420, as indicated by dashed arrow 413; in some non-limiting examples an alarm can be by any combination of flashing light, audio message, sound effect, vibration, message sent to a smartwatch, etcetera. An example use of such an alarm includes alerting person 420 that a query received by device 410 (such as through audio pickup of queries 424, not shown for clarity) is in some way what can here be called “inappropriate,” such as because the query goes beyond those allowed generally by the protocol and/or agreed between the parties related to a mutual random value and/or in number, type, or otherwise.

Referring now to FIG. 4B, some elements introduced already in FIG. 4A are included here to indicate the columns of a protocol diagram. Accordingly, as will be appreciated, medium 430 is shown labeling the leftmost column, followed, from left to right, by person(s) “a” 420; device(s) 410; device(s) 415; and person(s) “b” 425. Vertically, along the left side of the figure, labels indicate three portions of the protocol, that here can be referred to as: “setup,” “repeat,” and “prove.” The first protocol portion, under the rubric “setup,” would typically it is believed, in at least some exemplary configurations, be performed once initially for a particular choice of party 420 and counterparty 415, 125.

The second protocol portion, which includes the questions and answers, is shown under the rubric “repeat,” since it is anticipated that there can be a series of questions and corresponding answers; however, this is just an example and all manner of intermingling of questions and answer multiplicities with varying scope and timing is anticipated. The division in portions is for clarity, as will be appreciated, and is only a non-limiting example. For instance: various setup aspects can be moved to the repeat section and/or the prove section (to be described); various aspects that are shown as repeated can be moved to the non-repeated sections and/or repeated along with portions of those sections; and proof can be divided into all manner of parts and included in other portions. Moreover, the notion of a strict ordering can be replaced by various parallel and/or partly overlapping processes, all as will be understood.

The third portion, showing a provision of at least potentially convincing information primarily from device 410 to device 415 is provided, under the rubric “prove.” It will be understood, however, while various types and variations of so-called “zero-knowledge” and “minimum disclosure” proofs are known suitable here. Some proofs may be so-called “non-interactive” and not require information flowing from right to left in the figure; whereas so-called “interactive” proofs, which can be of various types and provide various levels of convincing, including so called “cut and choose” methods, may use so-called “challenges” and/or “mutually random” values, or other flows from right to left, as indicated by the here distinguished left-pointing arrowhead formed from line segments.

The example setup portion includes several transmissions from one column to another column, as indicated by various types of arrows shown in the portions, as will be described next.

The first arrow, proceeding top down in the figure and the setup portion, is person 420, at least being aware of and/or choosing and/or optionally forming, the secret indicia and/or information on and/or in medium 430. The bracketed question mark “(?)” notation indicates that choosing is just an example. For instance, the device 410 can choose the secret in some other examples, or the secret can be partly from each of these two sources and/or result from an interaction between them. In some of these examples the secret can be words and/or other symbols in a sequence, matrix or other structure. One example believed attractive known form is a so-called “passphrase” that the user creates at random, is hard for anyone to guess, and the user can remember. Another attractive popular example is so-called “BIP39” mnemonic codes, where words from a list are arranged in a sequence.

The second arrow is for the case when the secret symbol sequence is not otherwise known to the device 410. In this optional variant, what can here be referred to as a “scan” of the media (optional, as indicated by the “(?)” symbol, as mentioned), allows the device 410 to recognize the symbol information, such as by so-called OCR and/or handwriting-recognition, or the like, as will be understood. In some examples, device 410 can optionally confirm what was recognized by displaying and/or otherwise providing some form of rendering of all or part of it to person 420.

The third arrow is from device 410 to device 415. Two values are shown comma-delimited: “commit” and “pubkey.” These are examples for clarity as will be appreciated by those of skill in the cryptographic arts. For instance, commit can be a cryptographic commitment or “image” under a cryptographic function of one or more values that can later be used as a basis for various proofs and/or opened, all or in part, by the party or device 410, to convince the counterparty or device 415 that received them and that receives the opening information and/or proof, that corresponding what are called “pre-image(s)” were known to and fixed by the first party at least by the time the commit was received, as will be understood. As just one example, the secret symbols would be committed to, individually each in cryptographically hidden form, as will be understood; as another non-limiting example, the corresponding private key and/or public key is committed to as well, however, the fact that the secret symbol pre-images result in the corresponding private-key and/or public-key would typically be “proved” by the party proffering the commit later as will be described with reference to that portion.

What can here be called “combined information” can include the commits to the secret symbol sequence and the private key and/or public-key information, in some examples, so that when the proof (described below) is performed, the counterparty can have some significant level of confidence that the symbols known to the person 420 do confer in practice at least an ability of the person 420 to obtain the private key. (The level of confidence can be high, such as exponentially high in a security parameter based on certain cryptographic assumptions, or, as just one other non-limiting example, the modest fraction resulting from a simple so-called “cut-and-choose” protocol.)

The fourth arrow is also between the device 410 and device 415 but is double-ended and is an optional cryptographic protocol for the creation of a mutual random value. Such protocols are known in the art, for example when one party provides a bijective commit to the second and then the second reveals a value that is to be added bitwise to the value that was committed to when the commit is opened.

The fifth arrow, again optional and between device 410 and device 415, is labeled “question parameters,” which can be used here to mean that the device 410 can provide the counterparty device 415 with some information about the secret symbol sequence, such as in accordance with a predefined mapping from the mutually random value just described, that can be used in one or more queries. For instance, but as just one non-limiting example, device 410 can say in effect, “one but not both of the symbol pairs ‘dh’ and ‘pr’ appear in the first 10 symbols,” where this type of questions and even restrictions on the actual and fake symbols can be determined in whole or in party by the mutual random value. This would then allow device 415 to provide questions to person 420 of the form, for example, “Which appears in the first ten symbols, the first or the second of these two letter groups: ‘dh’ and ‘pr’.”

Referring next to the repeat portion, the overall structure of the example illustrated for clarity is of a query to person 420 followed by a corresponding response by person 420. This example repeat portion can be iterated a number of times, such as a predetermined number of times, a random number of times, a number of times that is announced by the counterparty when some criteria is reached, etcetera.

The first line of the repeat portion shows an example query emanating from device 415; however, queries can also come in whole or in part or in whatever combination and/or aspect from person 425, shown as dashed arrow. The query is ideally made available to device 410, as indicated by the notation of the arrowhead mid line. This is what allows device 410 to optionally receive the query and to then check as has been mentioned that the query, along with any previous iterations of the repeat, is within the appropriate set of queries, such as those determined by the mutually random value already described and/or by what has been sent between the parties and/or by pre-determined protocol aspects.

The second line of the repeat portion is for the case where the check determines that the queries are not appropriate. In this case the “alarm” signal can be provided by device 410, such as but not limited to person 420, as shown by the dashed line. The alarm signal, as already mentioned, can be aimed at stopping person 420 from answering improper questions that can, for instance, be at least unnecessarily and/or too revealing directly or indirectly of the secret symbols.

The third line, labeled “view,” is where person 420 optionally at least looks at, through site 440, media 430 to find the answer to the query. The queries and the number of secret symbols are believed ideally designed so that most people may need to either have a clear memorized image of the symbols or need to refer to the media to answer the queries. This, it is believed, can give confidence to the counterparty, including because of the site 445 and the barrier 455, that the person 420 does know and can have memorized the secret, such as a passphrase allowing the private key to be arrived at, as will be appreciated.

The fourth line is the answer to the query provided by person 420 to the counterparty. The device 415, and optionally as shown by dotted line the person 425, receive the answer. The queries and corresponding answers are what can be verified in the proof portion described next.

Referring finally now to the proof portion in operation, the overall structure of the example illustrated for clarity includes a proof shown at the end, after setup and iterations of the repeat portion, as have already been described. The distinguished arrowhead formed from line segments on the left, as already mentioned, shows interaction by the counterparty in the proof. The proof, wherever distributed and included in the overall protocol, but shown here for clarity combined, is believed to be in effect convincing the counterparty at least of the mutual consistency of the protocol values: pubkey also called here “public key information,” commit as described earlier, queries from the repeat portion and answers from the repeat portion. Various cryptographic proof techniques known in the art are believed suitable. As just one non-limiting example, a zero-knowledge proof that: private key information, corresponding to public key information, is readily computed from the symbol information committed; and that the answers to the queries are consistent with the symbol information committed. Some proof systems are believed to provide privacy of the secret symbols based on computational assumptions and be statistically convincing while other examples can protect secrets unconditionally but be convincing only based on the computational assumptions.

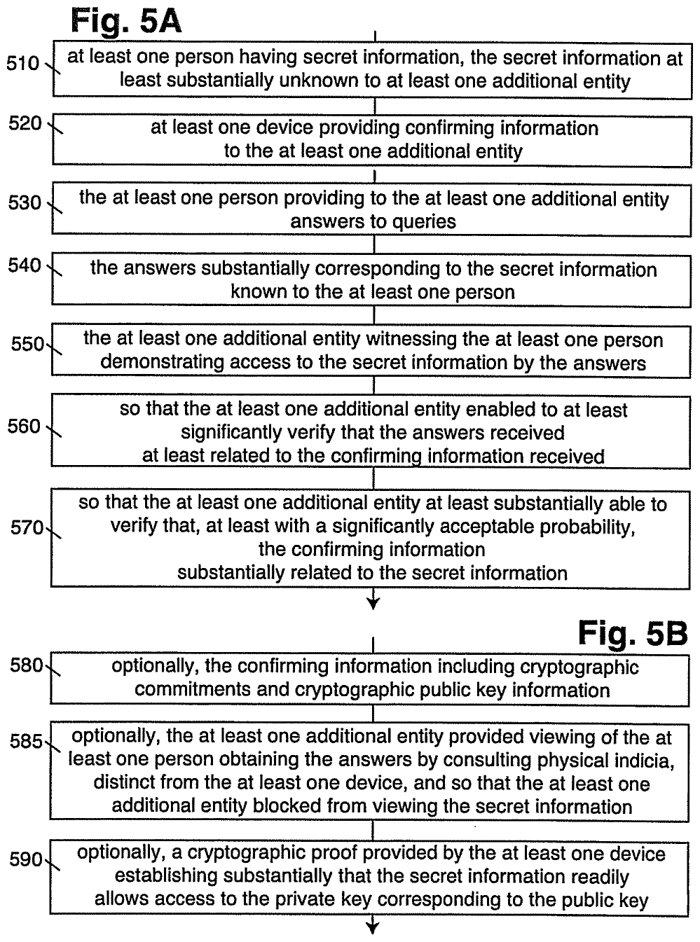

Turning now to FIGS. 5A and 5B, exemplary flowcharts are provided of the proof of human knowledge of private key protocols accordance with the teachings of the present invention. FIG. 5A is a flowchart of an overall process; FIG. 5B includes exemplary aspects of the overall process.

Referring now first to FIG. 5A, and more specifically to box 510, it can here be said that “at least one person having secret information, the secret information at least substantially unknown to at least one additional entity” to mean that the at least one person knows some secret information, such as for instance, a password, passphrase, random number or the like. In some examples, it is all or partly provided by a computer or other means, in other examples the person(s) are able to make it up and perhaps more casily memorize it.

Referring to box 520, it can here be said that “the at least one device providing confirming information to the at least one additional entity” to mean that the at least one device provides information to the counterparty that allows the counterparty to confirm various aspects, such as including that the answer to the queries are correct, that the secret of the at least one person is committed to, that a proffered public key does correspond to a private key that is readily computed from the secret information, and so forth.

Referring to box 530, it can here be said that “the at least one person providing filtered information to the at least one additional entity” to mean that for example the at least one person provides answers to queries or otherwise provides information related to the secrets that do not reveal too much about the secrets. For instance, as just one example, a random physical experiment could determine a particular symbol, such as by position or value, from among the symbols encoding a secret and the at least one person would supply just that symbol to the at least one additional entity.

Referring to box 540, it can here be said that “the filtered information substantially recognizable by the at least one person as corresponding to the secret information” to mean that the filtered information is of such a character that the at least one person can recognize that it is related to the secret information, such as by being the answer to the corresponding query.

Referring to box 550, it can here be said that “the at least one entity witnessing the at least one person demonstrating at least some access to at least the filtered information” to mean that the at least one additional party can see or otherwise sense or determine that the at least one person is showing in some way that they have access to the secret information, such as in answering a query. In some examples, however, it will be understood that some persons may be able to answer queries of different complexities with the symbols in memory and not recorded on media. In some examples, the person will write a passphrase behind a privacy screen and refer to it while answering questions, with at least some sensing by the at least one additional entity able to observe this process but not able to readily at least determine the portions of the secret that are not provided as filtered information.

Referring to box 560, it can here be said that “\so that the at least one entity enabled to at least significantly verify that the filtered information received at least related to the confirming information received” to mean that the at least one additional entity is able with at least some non-negligible probably and/or with some potentially somewhat realistic computational assumption, to verify that that the filtered information at least in some way corresponds to the filtered information. For example, verifying a so-called “zero knowledge” and/or “minimum disclosure” proof, even if its security parameter is low or its computational assumption strong. In some examples, combining a number of “weaker” proofs may yield sufficient confidence for the at least one additional entity.

Referring to box 570, it can here be said that “so that the at least one additional entity at least able to significantly verify that, at least with a significantly acceptable probability, the confirming information significantly related to the secret information” to mean that, in a similar way as with box 560, that the at least one additional entity is able to develop some confidence that the secrets, such as recorded as indicia on media by the at least one person, relate to the confirming information. For instance, when the confirming information includes such things as a public key and a commitment to the secret information, as mentioned earlier, then correspondence of both of these with the confirming information is verified.

Referring to box 580, it can here be said that “optionally, the confirming information including cryptographic commitments and cryptographic public key information” to mean that the confirming information includes and/or is isomorphic to and/or determines in a readily computed manner a cryptographic commitment of at least the secret information and the public key. Put differently, there is a public key that the at least one person and at least one device can compute a private key for that is related to the secret information and the corresponding public key is at least verifiable as corresponding to the confirming information.

Referring to box 585, it can here be said that “optionally, the at least one additional entity provided viewing of the at least one person obtaining the filtered information from a physical record distinct from the at least one device and so that the at least one additional entity blocked from viewing the secret information” to mean that the queries are answered and that the answers at least to some extent and with some significant probability do correspond with the confirmation information, such as by relating to the secret symbols committed to and those being incorporated in the confirming information.

Referring to box 590, it can here be said that “optionally, a cryptographic proof provided by the at least one device establishing substantially that the secret information readily allows access to the private key corresponding to the public key” to mean that proof that the secret information relates to the public key is such that the private key is verifiably readily derived from the secret information used in making the proof.

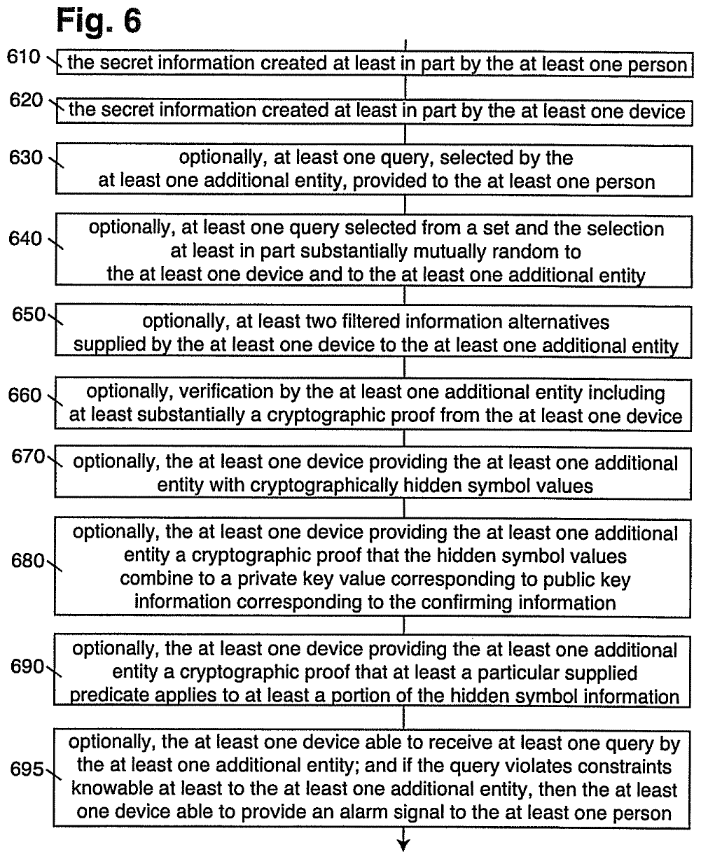

Turning now to FIG. 6, exemplary flowcharts are provided of the proof of human knowledge of private key protocols aspects in accordance with the teachings of the present invention.

Referring now more specifically to box 610, it can here be said that “the secret information created at least in part by the at least one person” to mean that at least in some examples the secret information can be created by the at least one person, such as for instance by one or more persons making “free” choices of words or other symbols to include in the secret information, including by physical random experiment and simple choice.

Referring now more specifically to box 620, it can here be said that “the secret information created at least in part by the at least one device” to mean that at least to some extent the at least one device can supply and/or assist the at least one person in forming the secret. For instance, as just some examples: the device can provide one or more what may here be called “alternative” values for the person to choose between; the device can check the adequacy of the random value created by a person; and/or the person can operate the device and the value result from the pattern of operation of the device, such as a function of a curve drawn on a screen.

Referring now more specifically to box 630, it can here be said that “optionally, at least one query selected by the at least one additional entity provided to the at least one person” to mean any way that the additional party can select a query, from whatever space, and provide it to the at least one person.

Referring now more specifically to box 640, it can here be said that “optionally, at least one query selected from a set and the selection at least in part by a value that is substantially mutually random to the at least one device and to the at least one additional party” to mean that all or part of the choice of what may here be called “allowed” queries can in some examples be by a value that is what can be called here “mutually random,” to mean that neither party nor counterparty can make the outcome a value that they choose or favor.

Referring now more specifically to box 650, it can here be said that “optionally, at least two filtered information alternatives supplied by the at least one device to the at least one additional entity” to mean that the at least one device provides the at least one additional party more than one potential set of values for the filtered information, where at least less than all of the values are wrong. By providing some information about the secret to the counterparty, for one thing, the counterparty is able to authenticate this by presenting the at least one person with it. For another thing, the correspondence between the secret information and the confirming information is believed to be enhanced. As an example, two alternative short letter sequences can be provided to the counterparty and the query can ask which one of the two is from the secret.

Referring now more specifically to box 660, it can here be said that “optionally, verification by the at least one additional entity including at least substantially a cryptographic proof from the at least one device” to mean that the at least one device provides, at least to some extent and under some assumptions, a so-called “zero-knowledge” or “minimum disclosure” proof, or the like, to the counterparty. Such proofs would typically relate the various values already known, such as the filtered information, the confirming information, and/or the public key.

Referring now more specifically to box 670, it can here be said that “optionally, the at least one device providing the at least one additional entity with at least a sequence of cryptographically hidden symbol values” to mean that the secret symbols, such as in the sequence order, are provided to the counterparty each transformed. An example type of transform, anticipated in part elsewhere here, in just one example, is where the secret element is shown to be in a certain limited range and the blinding factor included with it a known power of a separate generator. Various so-called “cut and choose” methods can assist with such proofs and/or they can be using isomorphic encryption, all as is known.

Referring now more specifically to box 690, it can here be said that “optionally, the at least one device providing the at least one additional entity a cryptographic proof that the hidden symbol values combine to a private key value corresponding to a public key value corresponding to the confirming information” to mean that additional proof and/or construction allows the counterparty to check that combining the secret values yields the private key corresponding to the public key associated with the confirming information. Such an approach, anticipated in part elsewhere here, can in some examples allow the combining of the hidden secrets, the unblinding, and the resulting value including the secret values in the exponent of a fixed generator, which is the form of the public key. All manner of proof systems, so-called MPC, and whatsoever can be used to verify such constructions, as will be understood.

Referring now more specifically to box 690, it can here be said that “optionally the at least one device providing the at least one additional entity largely a cryptographic proof that at least a particular supplied predicate applies to at least a portion of the hidden symbol values” to mean that whatever predicate, such as a first order predicate calculus predicate and/or for instance a list of satisfying values, can be demonstrated by the one party to the counterparty as applicable to the secret. For instance, a proof could be provided that the predicate “has an odd number of internal spaces” could be proffered and proved, as will be understood, using proof techniques known in the art.

Referring now more specifically to box 695, it can here be said that “optionally, the at least one device able to receive at least one query by the at least one additional entity; and if the query violates constraints knowable at least to the at least one additional entity, then the at least one device able to provide the at least one user with an alarm signal” to mean any way to allow the at least one device to monitor the queries and alert at least the at least one person that a particular query is inappropriate. This can for instance: stop the counterparty from obtaining to much information about the secret; alert the at least one person that the counterparty interaction should at least be aborted; alert the counterparty that they may have made a mistake; and/or call attention to attempted cheating and/or errors.

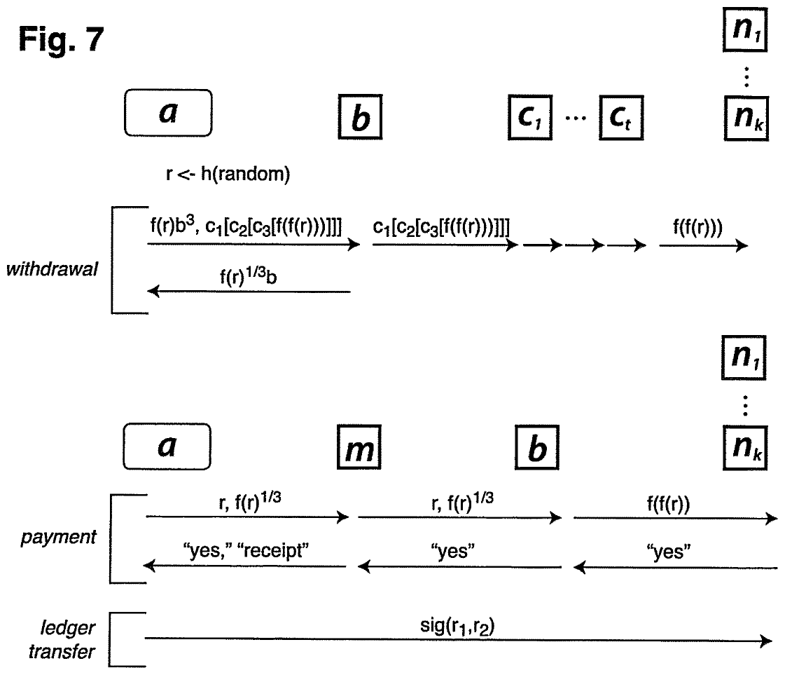

Turning now to FIG. 7, a detailed combination flow and cryptographic diagram for an exemplary embodiment of a value transfer system, including privacy and quantum-resistant aspects, is shown in accordance with the teachings of the present invention. Across the top of each of the withdrawal and payment portions of the diagram are shown exemplary parties, below which the messages communicated between the parties are shown on arrows in abbreviated cryptographic notation, as types usual and for clarity and as will be understood. The terminology used here of “withdrawal” and “payment” are intended to include whatever similar more general “transfer of value,” as will be appreciated; similarly, “withdrawer” and “payer” and “issuer” can be used for clarity, as will also be understood.

The exemplary “parties” in the withdrawal protocol, labeled across the top as mentioned, are what can here be called: (a) “user” or “customer” or “payer” or “withdrawer”, called here “a”; (b) the “commercial bank” and/or “central bank” in combination or separately for CBDC settings for clarity also as “bank”; (c) the mix “nodes” c(1), c(2), . . . c(t); and finally the “blockchain/ledger” comprised of nodes shown as n(1), n(2), . . . n(k). Note: subscripts are shown in the Figure but parenthesis notation is used here in the description for clarity.

The first message sent in the withdrawal, which is from the user to the bank, is shown as comprised of two components: (1) the blinded image of I; and (2), the value f(f(r)), what might be called the double application of the function f to r, as the payload of a message prepared as input for a mix. Where f is nearly or fully a so-called “one-way” function that is wide enough and complex enough to be believed infeasible for inversion with substantial likelihood even by a quantum computer, as will be appreciated. And where the mix is shown as comprised of nodes c(i) as mentioned above and each with public key shown in a form similar to the node name for clarity.

Next the bank sends two things: return the signed but still blinded first component to the user “a” and provide the second component as input to the mix cascade. The user can check and unblind the value received, as is known. And then the mix nodes, of the ordering shown that can be called a “cascade,” can decrypt the payload successively while each node permutes the batch of such items before providing the decrypted batch to the next node in the cascade. Finally, as shown as the what can be called “output” of the mixing is what can be called the “payload,” which is then provided for inclusion on the blockchain/ledger, such as for instance by being included among the leaves of a so-called Merkle tree.

The exemplary “parties” in the payment protocol, labeled across the top as mentioned, can be called here: (a) as above, the user or customer, or “a,”; (b) the “retailer” and/or “payee” as will be understood as the recipient of value at least in some cases; (c) as already mentioned the commercial bank and/or central bank or combination for clarity bank; and (d) the blockchain/ledger comprised of nodes shown as n(1), n(2), . . . n(k). (Note: again subscripts are shown in the Figure but parenthesis notation is used here for clarity.)

The first message sent in the corresponding subsequent what is labeled “payment” or can be called “value transfer” by the user or payer or withdrawer “a” is shown including two components: (1) the random number/value “r” (shown as an image under “h” where that function can be a so-called “whitener” of a raw random value, but can in some examples, includes optional transformation into a pre-image under a one-way function or into a public key, as will be understood can be used for subsequent authentication); and the “bank's signature on the image under “f” of “r”, shown as the third root as will be understood, for instance, in the modular arithmetic system where the factorization of the modulus is known typically at most to the bank or the central bank, such as in in one or more shares known to various entities including so-called “TRM” or banks. This pair can in some examples be checked for correct form by the payee or merchant before being sent in to the bank(s) in the second message.

The first bank and/or the second bank and or the single bank can then for one thing check that the pair of values is well formed; that is, that applying “f” to the first component yields a residue class that is congruent to that resulting from applying the public exponent, “3” in the example for clarity, to the second component. For another thing, the bank(s) can check the blockchain or other record to ensure that applying “f” iteratively to “r,” or “h(r)” in some examples as mentioned, yields a value that has been recorded on the blockchain/ledger. If so, this is indicated in the figure by the nodes returning a “yes,” as will be understood to be any kind of lookup or verification that the value has been earlier stored. Then the bank(s) can return a “yes” or confirmation that the payment is accepted to the merchant/payee; and finally optionally the payee can provide a “yes” and/or a receipt to the payer (a).

Referring next to what can here be called “ledger transfer,” as indicated in the figure as an additional exemplary message shown. Such a message can, for example, as will be understood, be from the payer “a” to the blockchain/ledger, and include a signature and/or other authentication as will be understood, as authenticated by r(1), which is at least related to “r,” to request a transfer of all or part of the value payed to be under the control of a second authenticator, shown as “r(2)”. Typically, and as is known in the blockchain/ledger art, such a transfer may be referred to as an “on-chain transfer from one wallet ID to another wallet ID,” as are well known.

Variations are anticipated including as illustrated by the following non-limiting example instances: (1) the payload itself indicates whether the value is suitable for payment to a merchant or whether it is to be transferred to another wallet ID; (2) a so-called “offline electronic cash,” as disclosed by the present applicant in a previously issued U.S. Pat. No. 4,987,593, type signature can be used to move the funds either to another party or to another authenticator, so that if the payer attempts to what can be called “double spend” the value, then at least the payer and/or payer account will be identified; (3) a third party entity, such as one of the banks or another legal entity and/or means, that servers to prevent double-spending of the value, such as by a policy of issuing a signature authorizing the first requested use only.

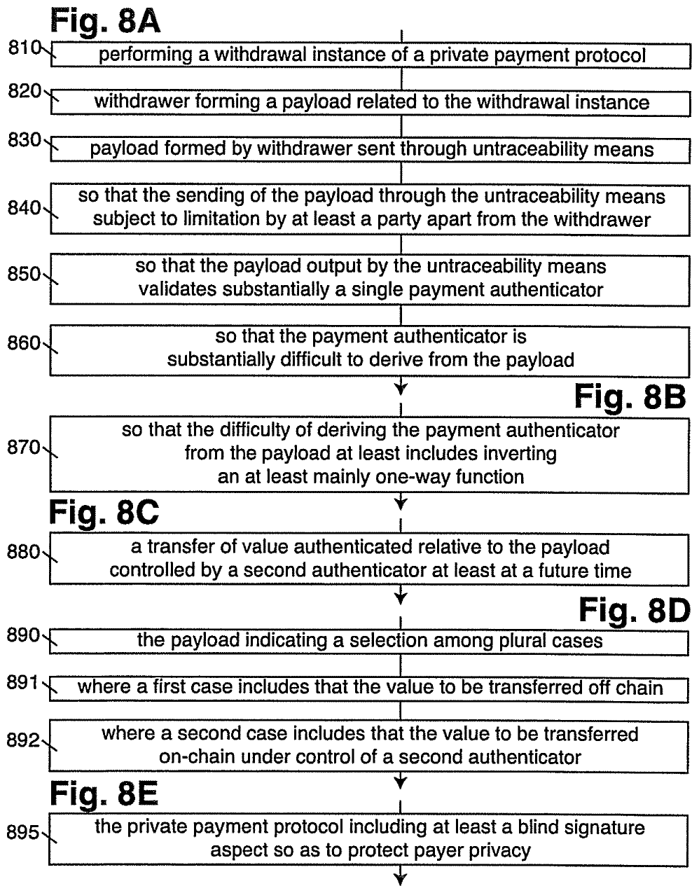

Turning now to FIG. 8A-E, an exemplary combination flow chart and cryptographic protocol is shown in accordance with the teachings of the present invention. FIG. 8A is the overall withdrawal protocol; FIG. 8B relates to the quantum security against counterfeiting; FIG. 8C is a transfer on a blockchain/ledger of the value; FIG. 8D is recording on the blockchain/ledger the type of further transfer; and FIG. 8E is the use of a blind signature payment system.

Referring now to FIG. 8A, and more particularly to box 810, it can here be said that “performing a withdrawal instance of a private payment protocol” to mean any cryptographic protocol or the like that includes value being put at the disposal of the withdrawer party to a greater extent than prior to the protocol and where the future transfer of that value has at least some protection of the privacy and/or private information related to the withdrawer.

Referring to box 820, it can here be said that “withdrawer forming a payload related to the withdrawal instance” to mean that the withdrawer party and/or a designate forms at least one value called here a “payload” that is in some way related to the withdrawal protocol instance referred to in box 810. For instance, the payload can be taken to be the image under a one-way function of a value that will have to be shown at the time of payment, such as for instance the random pre-image or public key in a so-called “blind signature” payment system. As another example, when a private payment is made a value such as the result of a symmetric cypher or otherwise guarantecing the uniqueness of the payment can be used as the pre-image.

Referring to box 830, it can here be said that “payload formed by withdrawer sent through untraceability means” to mean that the payload as already described with reference to box 820 is sent through means that at least obscures its origin. Examples are so-called dead-drop and mix networks.

Referring to box 840, it can here be said that “so that the sending of the payload through the untraceability means subject to limitation by at least a party apart from the withdrawer” to mean access to sending and/or the preventing of blocking and/or the tagging of payloads sent through the untraceability means is limited. For example, the issuing bank(s) can control access or marking so that only those payloads are present or properly marked at the output of the untraceability system that correspond to respective withdrawals. For example, one payload output for one unit of value withdrawn or different untraceability means for different amounts of value.

Referring to box 850, it can here be said that “so that the payload output by the untraceability means validates substantially a single payment authenticator” to mean that the outputs of the untraceability means, at least those appropriately marked and/or not blocked, correspond to respective payment authenticators, at least of commensurate value, as will be understood. In order for the withdrawn value to be spent, in the examples, a matching output would be linked and used up; accordingly, it is believed, that counterfeiting value in such a system would mean either adding entries to the output, which is what is being prevented here, or possibly using an output entry by the counterfeiter, as will be addressed with reference to FIG. 8B.

Referring to box 860, it can here be said that “so that the payment authenticator is substantially difficult to derive from the payload” to mean that a computational barrier is believed to be in place as a consequence of the cryptography employed.

Referring now to FIG. 8B, and more particularly to box 870, it can here be said that “so that the difficulty of deriving the payment authenticator from the payload at least includes inverting an at least mainly one-way function” to mean, but as just one non-limiting example, in order to find a payment authenticator from a payload, a one-way function must be inverted, and inverting that function is believed for example to be infeasible with high probability even by a quantum computer using algorithms that are practical to derive, then counterfeiting at least in mass would, it is believed, be infeasible through that route.

Referring now to FIG. 8C, and more particularly to box 810, it can here be said that “a transfer of value authenticated relative to the payload controlled by a second authenticator at least at a future time” to mean that the value can be transferred to be under the control of a second authenticator, such as a second public key, by “spending” the value corresponding to the blockchain/ledger entry related to the payload, such as by the payload being a public key and a signature being formed that transfers the value to be under the control of a different or second public key. As just one example, the second public key can be arrived at by a protocol between parties so as to be what can be called “jointly” controlled so that cooperation of the parties can form a signature related to the second authenticator. More specifically, as just on example, the payload can be taken as a “wallet ID” on a blockchain and the private key allowing signatures to be made that validly correspond with that wallet ID can be made with a private key that was formed by the withdrawer; the joint custody wallet ID this signature then transfers the value to, such as on a blockchain/ledger.

Referring now to FIG. 8D, and more particularly to box 890, it can here be said that “the payload indicating a selection among plural cases” to mean that the payload information already encodes in some way a selection between plural transfer rules.

Referring to box 891, it can here be said that “where a first case includes that the value to be transferred off chain” to mean that for at least one or more transfer rules encoded in the payload, the value is to be paid to a party on some other blockchain/ledger and/or some other payment system.

Referring to box 892, it can here be said that “where a second case includes that the value to be transferred on-chain under control of a second authenticator” to mean that for at least one or more transfer rules encoded in the payload, the value is to be moved on the blockchain/ledger to another wallet ID as would at least typically be authorized by a signature made with the private key corresponding to the public key encoded in the payload.

Referring now to FIG. 8E, and more particularly to box 895, it can here be said that “the private payment protocol including at least a blind signature aspect so as to protect payer privacy” to mean that the private payment system referred to in box 810 already described with reference to FIG. 8A is a so-called “blind signature” based payment system, such as that well known in the art as eCash and/or as described elsewhere here, as will be appreciated.

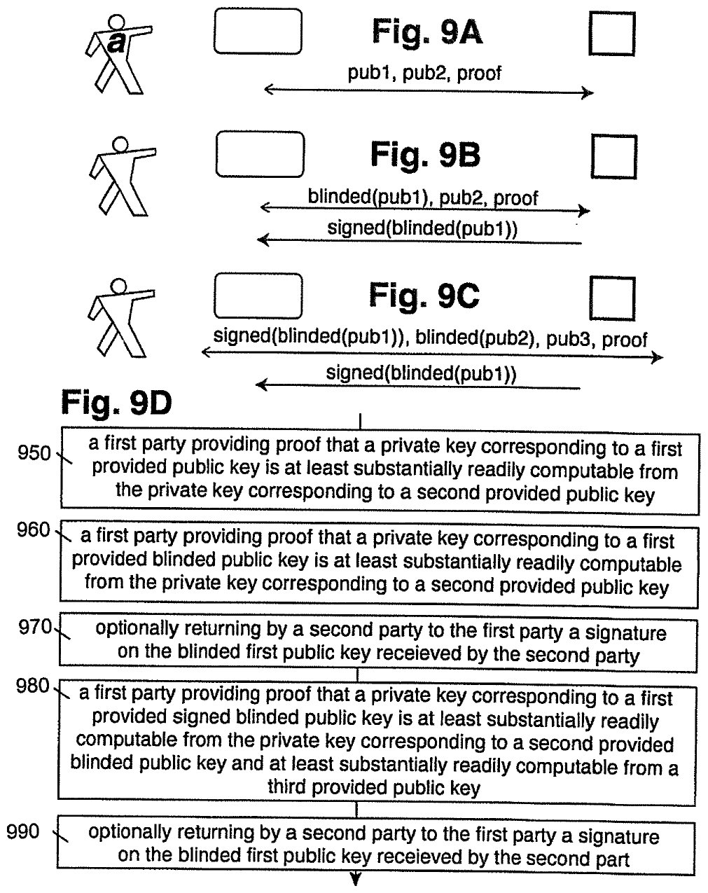

Turning now to FIG. 9A-D, detailed combination block and cryptographic protocol diagrams and flowcharts for private key computability proofs are shown in accordance with the teachings of the invention. FIG. 9A shows a protocol for convincing that two public keys have private keys that can readily be computed from each other; FIG. 9B shows a protocol for convincing that two public keys, one provided to one party only in blinded form, have private keys that can readily be computed from each other; FIG. 9C shows a protocol for convincing that three public keys, one provided to one party only in blinded form and another provided in signed blinded form, have private keys that can readily be computed from each other; and FIG. 9D is a flowchart detailing the three protocols and including the return of signed blinded public keys in the second and third protocols.

Referring more specifically now to FIG. 9A, a first party labeled “a” is shown on the left with a computer, such as a smartphone 910, communicating with a second party having a computer 920. Three example components of a message from the first party to the second party are shown: a first public key “pub1,” a second public key “pub2,” and a proof that the private key of the first public key is readily computable from the private key of the second public key, or what is believed here often the case and as useful, that the private keys are computable from each other.

Referring next to FIG. 9B, a first party again is shown on the left, though in this example potentially anonymous or pseudonymous, with a smartphone communicating with a second party. Four example components of a message from the first party to the second party are shown: a first blinded public key “blinded(pub1)”; a second public key “pub2”; a zero-knowledge or minimum disclosure or related proof that the private key of at least one of the private keys is readily computable from the other private key; and an optional, as indicated by square brackets “[ ],” predicate that defines a condition that the proof convinces holds on the relation between the two private keys. As one example of a predicate, one private key can be defined as the other private key with a constant value added or with a constant bitstring xored; as another non-limiting example, the predicate can include multiple such constants with the proof ensuring that the property holds for an undisclosed one of them; and as a further example, without loss of generality, the predicate can define a set of properties related to each of the private keys and to their combination.

Referring this time to FIG. 9C, a first party again is shown on the left, potentially anonymous or pseudonymous, with a smartphone or whatever device communicating with a second party device as shown on the left. Four example components of a message from the first party to the second party are shown: a first signed blinded public key “signed(blinded(pub1)),” a second public key blinded “blinded(pub2),” a third public key “pub3,” and a zero-knowledge or minimum disclosure or related proof that the private keys of the public keys combination are readily computable from each other. A predicate, similar to that already introduced with reference to FIG. 9B, whether related to two or three of the private keys, can be used here, as will be understood but is not shown for clarity.

Referring to the combined flowcharts of FIG. 9D, five flowchart boxes are shown as a single flowchart; however, the first and second and fourth can in some examples stand alone or the second and third and/or the fourth and fifth.

Referring to box 950, it can here be said that “a first party providing proof that a private key corresponding to a first provided public key is at least substantially readily computable from the private key corresponding to a second provided public key,” to mean that by whatever zero-knowledge or minimum disclosure or other related cryptographic proof or convincing method the party supplying the public keys convinces the second party and/or one or more computers of the second party that the private keys corresponding to the two public keys supplied are related in a way that is readily computable by the first party and could be used by the first party to compute one from the other party. As a non-limiting use case example, for concreteness as will be appreciated, the first party can be a customer of bank and wish to register a new private key, such as to switch to the new key or to require both keys be used to authorize withdrawals, without the first party conducting with the bank the full protocol as described with reference to FIG. 5AB.

Referring to box 960, it can here be said that “a first party providing proof that a private key corresponding to a first provided blinded public key is at least substantially readily computable from the private key corresponding to a second provided public key,” to mean any cryptographic process between at least two participants where one provides a blinded public key and a plaintext public key to a second participant and some form of cryptographic proof or related technique, such as zero-knowledge and/or minimum disclosure, is provided by the first party to the second party with the effect that the second party becomes at least reasonably convinced that the private key corresponding to the blinded public key and the private key corresponding to the second public key are at least in some sense readily computable one from the other, whether only a particular one to the other, such as with a one-way function, or each from the other.

Referring to box 970, it can here be said that “optionally returning by a second party to the first party a signature on the blinded first public key received by the second party,” to mean that after the second party has become convinced the second party releases, such as to the first party, the public key digital signature or the like related to the blinded public key as described with reference to Box 960. As a non-limiting use case example, for concreteness as will be appreciated, the first party can be a voter and the second party a so-called “registration authority” for plural elections in which the voter may from time to time wish to vote. By obtaining the blind signatures on public keys, one for each election, the voter can sign for each election the respective voted ballot without the registration authority learning which voter has cast which ballot.

Referring to box 980, it can here be said that “a first party providing proof that a private key corresponding to a first provided signed blinded public key is at least substantially readily computable from the private key corresponding to a second provided blinded public key and at least substantially readily computable from a third provided public key,” to mean that one party supplies a second party with a number such as three values and a proof that the private keys of the values, according to the agreed definition of how the values should be formed, are at least readily computable from one another in at least one way. The values can be in some examples a signed blinded public key, a blinded public key, and a plaintext public key.

Referring to box 990, it can here be said that “optionally returning by a second party to the first party a signature on the blinded first public key received by the second part,” to mean that with reference to the protocol of box 980, that in a manner similar to that already described with reference to box 970, the second party provides the first party with a signature on the blinded public key; however, the second party would at least have the opportunity to check the proof to some extent before the transfer of the signature in effect becomes irrevocable.

Turning now to FIGS. 10A-C, detailed combination block and cryptographic protocol diagrams are shown in accordance with the teachings of the invention. FIG. 10A shows the blocks in an arrangement for the protocol; FIG. 10B shows a message exchange protocol ladder diagram; and FIG. 10C shows multiple constituents cooperating with a single device.

Referring more specifically now to FIG. 10A, on the “person” 1020, a smartphone or other digital device 1010a, typically owned and/or used by the person 1020, such as will be described further with reference to FIG. 10C, is shown. A second device 1015, shown as a square, and can be one or more computers and/or networked devices, such as will also be described further with reference to FIG. 10C. Bidirectional communication link 1022, for communication at least between devices 1010a and 1015, such as for instance over bluetooth and/or Wi-Fi or other wireless and/or optical/IR and/or wired communication means with whatever cryptographic and/or quantum security, as may be known, is shown as a lightning arrow. The example person 1020, which can in some optional examples be more than one person, such as in the case of joint custody accounts for instance, as will be understood, is shown being able at least to “read” (for instance visually and/or tactically) media 1030, as suggested by close proximity in the diagram.

Arrow 1024 indicates what may here be called “queries” and/or “questions” or the like being provided by device 1015, in the example, to person 1020; similarly, solid line arrow 1026 indicates answer provided, for instance responsively, by person 1020 to device 1015.

In some examples, device 1010a optionally includes an alarm function as already described with reference to device 410 in FIG. 4AB. This is believed potentially useful in the present exemplary embodiment, for instance to protect person 1020 from device 1015 revealing more about the secret symbols than it should according to protocol. For clarity, however, the structure neither repeated nor described in more detail here.

Referring now to FIG. 10B, in a similar manner as in FIG. 4B, some elements introduced already are included to indicate the columns of a protocol diagram and along the vertical, the same labels are again used to indicate three similar portions of the protocol introduced here: “setup,” “repeat,” and “prove.” The setup portion would typically, it is believed in at least some exemplary configurations, be performed once initially, at least for a particular choice by party 1020 of device 1010a and counterparty device 1015. The second protocol portion, repeat, includes the queries and answers pairs as a sequence that is iterated, but can be configured as desired and already described with reference to FIG. 4B. The third portion, showing a provision of at least potentially convincing information primarily from device 1010a to device 1015, can be of various types, some examples of which have already been described with reference to FIG. 4B.

The first arrow of the exemplary setup portion is shown bidirectional for clarity to cover various examples for the secret symbols being created and known to the various entities, as already described with reference to FIG. 4B. The second arrow is from device 1010a to device 1015 and shows comma-delimited values “commit” and “pubkey” being sent as also already described with reference to FIG. 4B. Examples of mutual random values and query parameters, already described with reference to FIG. 4B, are believed potentially applicable here but not shown again for clarity.

Referring next to the repeat portion, the overall structure of the example illustrated for clarity is of a query to person 1020 followed by a corresponding response by person 1020 and, as described with reference to FIG. 4B, can be repeated in various ways. The first line of the repcat portion shows an example query emanating from device 1015 and made available to device 1010a, as indicated by the arrowhead mid line as will be understood that facilitates the alarm function not otherwise shown here for clarity. The second line, view, lets person 1020 optionally at least look at media 1030 to find the answer to the latest query. The third line is the query's answer provided to device 1015 by person 1020. The queries and corresponding answers are verified by the proof portion described next.

Referring finally to the proof portion, the operation is similar to that already described with reference to FIG. 4B. One aspect believed achieved in the present configuration, however, is that the person 1020 develops confidence that public key information, such as displayed by both 1010a and 1015, and optionally cross checked by communication and/or cameras and/or person 1020, does in fact have a private key that is readily reconstructable from the secret symbols.

Referring more specifically now to FIG. 10C, an exemplary configuration of a device 1010b, such as device(s) 1010a, 1015, 410, or 415, can include more than one physical package and/or element (1017, 1018, 1019) and these can communicate to create in effect a single entity for the purposes of the rest of the protocol. Some of the packages can be physically proximal, others can, for instance, be located remotely. The division of secret keys, the authentication of public keys, and the computation and communication conducted can allow a multiparty computation, as will be understood by those of skill in the art. Accordingly, whatever division of roles and/or permissions and/or trust and/ownership between the entities can be accommodated by such protocols, as will also be understood.

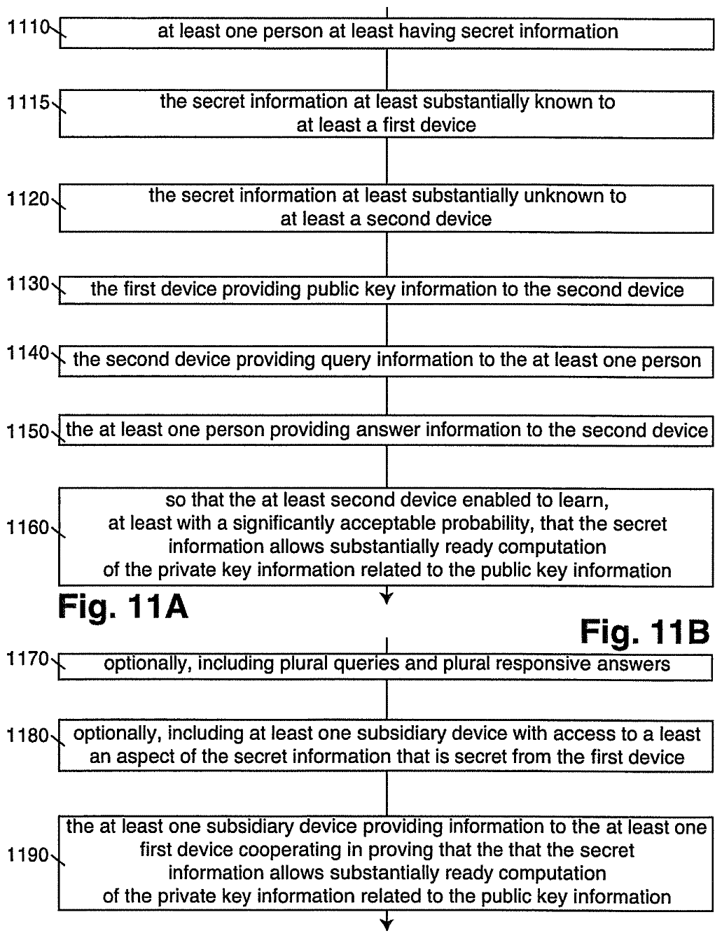

Turning now to FIGS. 11A and 11B, detailed combination block-diagram and flowcharts for a cryptographic protocol and view-blocking-arrangement are shown in accordance with the teaching of the invention. FIG. 11A includes the general case; FIG. 11B includes exemplary additions and variations.

Referring more specifically to FIG. 11A, and Box 1110 in particular, it can be said that “at least one person at least having secret information” here to mean that a person can have created a secret by various means and methods, such as including and/or received assistance in creating it and/or chosen it from parts presented and/or witnessed a physical experiment and/or be provided by a device with a secret and/or any combination of these. More than one person can, for instance, have part of a secret, whether the parts are simply concatenated and/or combined by some, for instance, group operation, as is known; moreover, more than one secret can be used in the cryptographic protocol.

It can, as per Box 1115, be said that “the secret information at least substantially known to at least a first device” here to mean that one or more information processing means or methods can know all or part of the secret information, such as if the device had provided the information to the person(s) and/or if the device in effect obtains the information from the persons, such as by entry, scan, photo, or whatever known data capture technique.

It can, as per Box 1120, be said that “the secret information at least substantially unknown to at least a second device” here to mean that an information processing means that is separate from that which knows the secret information does not know the secret information at least not as part of the setup and more generally whatever counterparty. It will be understood that the aim of the protocols is to prevent whatever “counterparty,” comprising whatever combination of persons and/or information processing, from learning enough of the secret information so that the remaining portion is not needed or can be determined by other means, such as trial and error, as will be understood.

It can, as per Box 1130, be said that “the first device providing public key information to the second device” here to mean that by whatever means the first device at least “locks in” and/or “commits” to and/or provides public key information in such a way that the second device is able to obtain it.

It can, as per Box 1140, be said that “the second device providing query information to the at least one person; the at least one person providing answer information to the second device” here to mean that queries are provided, such as by the counterparty and/or by the first device generally but known to and at least partly acceptable to the counterparty.

It can, as per Box 1150, be said that “the at least one person providing answer information to the second device” here to mean that the recipient of at least a portion of the queries includes the at least one person and that the at least one person able to answer at least some of the queries in a way that becomes known to the counterparty.

It can, as per Box 1160, be said that “so that the at least second device enabled to learn, at least with a significantly acceptable probability, that the secret information allows substantially ready computation of the private key information related to the public key information” to mean that by whatever means and/or method, some convincing and/or demonstration and/or giving of evidence and/or cryptographic proof, with whatever confidence level acceptable to the counterparty, that the secret information and/or what may here be called “secret symbols” can be used to compute and/or arrive at, by whatever practical and/or achievable means, the private key information corresponding to the public key information.

Referring more specifically to FIG. 11B, and Box 1170 in particular, it can be said that “including plural queries and plural responsive answers” to mean here that there are more than one query and answer of 1140 and 1150; for instance, but not limited to, a series of queries each with their respective and responsive answers. Other examples include multiple queries followed by multiple answer and/or combined answers, intermingled query groups and answer groups, and so forth.

It can, as per Box 1180, be said that “including at least one subsidiary device with access to a least an aspect of the secret information that is secret from the first device” here to means that at least a third device is configured to cooperate with the first device and that that at least third device has some aspect and/or portion and/or segment and/or whatever other knowledge related to the secret, so that its role is need and/or at least facilitative.

It can, as per Box 1190, be said that “the at least one subsidiary device providing information to the at least one first device cooperating in proving that the that the secret information allows substantially ready computation of the private key information related to the public key information” here to mean the further information and/or knowledge of the at least third device at least facilitating the convincing and/or demonstration and/or giving of evidence and/or cryptographic proof, with whatever confidence level acceptable to the counterparty, as described with reference to Box 1160.

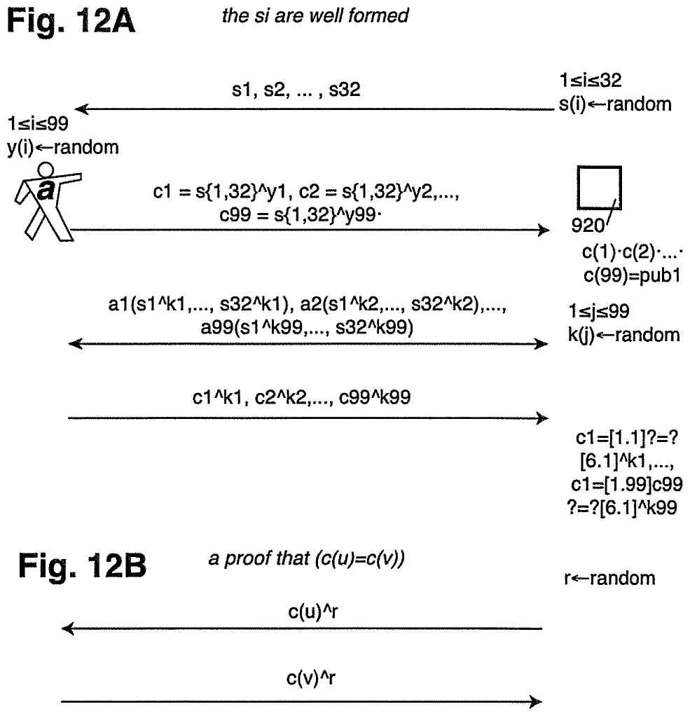

Turning now to FIGS. 12A-B, a detailed combination flowchart cryptographic protocol diagram of a symbol commitment and proof system is shown in accordance with the teachings of the invention. FIG. 12A is the proofs that the encrypted symbols are each properly formed; and FIG. 12B is an example proof that a particular symbol sequence position has the same symbol as a second particular symbol sequence position.

Generally, the protocol notation used is for clarity and concreteness, as will be appreciated, in a discrete log cryptographic system where the order of the group is public, the discrete log is assumed hard, the order of the exponent group is public. A well-known example is the residue classes modulo a suitable large prime. The “(mod p)” notation is assumed where appropriate, as will be understood, and omitted for clarity; equal symbols “=” are used instead of congruence “=,” and subscripts can be shown software-style, by concatenating the subscript value to the identifier, such as s1 instead of s₁. Also, exponentiation can be shown with the well-known carat “\hat{ }” notation instead of superscript. Almost every element in the group of prime order is believed a suitable choice, however the unpredictability of these by the opposite party is believed advantageous here and, as will be understood, suitable distributions and secrecy of keys are assumed.

The parties are on opposite sides of the arrows that indicate the flow of messages, where a double-arrow indicates a mutually agreed value or sub-protocol. In some cases for clarity the arrows are numbered with the natural counting numbers from top to bottom and the message content referred to for concision by notation like “[3.4]” to indicate the fourth component of the message content sent on the third arrow, as will be appreciated. A person is shown on the left, to indicate that the smartphone or the like is performing computation on behalf of the user or customer or citizen; the device 920 is shown on the right, to indicate that the counterparty and computer are performing that side of the protocol. Also for concreteness, example constant values are used, such as thirty-two for the number of possible symbols (such as “a-z, space, “−+&%*”) and ninety nine for (maximum) length of a linear sequence of such symbols used in an example instance of the protocol.

Referring now more particularly to FIG. 12A, the first step is the creation of thirty two generators at random (such as uniformly and independently, sometimes referred to as “IUD,” as will be understood), one to stand for each symbol value, such as s1 stands for the letter “a” and s2 for the letter “b,” and so forth, as mentioned. These are then sent to the user smartphone. Next the user smartphone is shown in effect already knowing the symbol sequence, such as would be supplied by the user to the smartphone as described already with reference for instance to FIG. 4. Each symbol in this symbol sequence is what can be called “blinded” separately by a respective y(i). For instance, s3 is blinded by being raised to the power y1 when, in the non-limiting example, the first symbol in the sequence is the letter “c.” The sequence of blinded symbols, c1 through c99, is shown by the arrow notation, already described, as being sent back from the left side to the righty side. Thus, as will be understood, the user smartphone has thereby committed to the (at least potentially) ninety-nine symbol long private sequence of the user. The curly braces “{ }” notation is used, as will be appreciated, to indicate that which of the actual symbols si is committing to in blinded form is not revealed to the counterparty by the commitment.

One thing that the counterparty, on the right, can do with the information received in message two is as shown form the public key corresponding to the committed secrets sequence. That key is the product of the ci and denoted pub1, as already described for instance with reference to FIG. 9.

The next phase of the protocol is believed, as will be appreciated, to convince the counterparty that at least each of the committed symbols ci contains at most one of the symbols si. An exemplary way to accomplish this described in detail here uses the well-known cryptographic primitive “ANDOS,” for example that described by Brassard, Crépeau, and Robert in “All-or-Nothing Disclosure of Secrets,” Proceedings of CRYPTO 1986, Lecture Notes in Computer Science 218, pages 73-86, Springer Verlag. Such sub-protocols allow a party to be sure that the counterparty obtains at most one of the secret values, not a combination of or more than one of them.

In the present inventive use of an ANDOS subprotocol, the party on the left chooses unpredictably a random power (IUD element of the exponent group) ki for each of the ninety-nine symbol positions. This same value is then applied as an exponent for each of the potential symbols ci for the respective position. Each of the ninety-nine instances of the ANDOS allow the party on the left to select one of the thirty two symbols si that has been raised to the corresponding one of the ninety-nine powers kj. Thus, the party on the left obtains “all or nothing” of the power of at most one si per ci.

This then allows the party on the left to compute the ci raised to the kj power. To do this, the party on the left raises the si\hat{ }k received to the corresponding blinding power yi., using the well known property of commutativity in the exponent. Each one of these is sent from the left party to the right party as indicated by the fourth arrow. Then the right party can verify each of these simply by raising the corresponding ci to the k1 power and checking for equality with the respective value received in the fourth arrow.

Referring to FIG. 12B, the example protocol described here is believed to allow the party on the left to provide in effect so-called cryptographic “proof” or the like to the party on the right that two symbol positions c(u) and c(v) in fact encode the same symbol, but without revealing which symbol s(i). Uses of this and related protocols will, for clarity, be described below after the specific protocol instance itself is detailed here.

The first step is the creation of r, a what is believed should be a mainly unpredictable random member of the exponent group, believed ideally IUD, by the party on the left. Next the party on the left sends to the party on the right, as shown by the arrow, the symbol c(u), for instance from FIG. 12A message two, raised to the r power. If, as is being assumed in this example, cu actually encodes si and cv also encodes si, then the party on the right knows the blinding factor quotient that converts cu to cv. Thus, it is believed as will be understood, that the message received in the first arrow can, for instance, be raised by the party on the right to the inverse power of yu and then raised to the power yv, to obtain the cv\hat{ }r.

Other properties of the ci are believed showable by the party on the right to the party on the left by combining multiple instances of the present protocol and/or by applying various general so-called zero-knowledge or minimum disclosure proofs techniques, such as those for establishing that various predicates hold on secret values known. As just one example, consider proving that at least one of multiple equalities holds, simply by using a subprotocol that shows that at least one of multiple possible secrets is known. For example, each such subprotocol can be converted to the same value by the verifier forming separate encryptions, each with a different one of the secrets as the key, and with the plaintext identical secrets. A tree structure of such secrets can provide, it is believed, for whatever so-called “monotonic” predicate on the secrets. Moreover, whatever zero-knowledge proof system can be used to show whatever predicates on the si within each ci.

An example use related to what has been described with reference to FIG. 9 is showing that two separate sequences have what can here be called “privately-related” private keys, such keys can be computed what can be called “readily” from each other. Given one private key and the public key of the related private key, a practical and/or modest amount of computation should allow the related private key to be recovered. One example way to prove that two public keys are privately-related is believed to be to prove that all the symbols si in the two sequences c1i and c2i match, except for in just one specific identified sequence position, c(13)≠c2(13). Thus, anyone who has all the secret symbols corresponding to the first public key can simply enumerate, in the example all thirty one other choices for the symbol in that position, checking each to see if the desired second public key is gencrated.

In some examples both the related public keys and the differing positions are known. In other examples, such as described with reference to FIG. 9, one of the public keys is only shown by the party on the right in a so-called “blinded” form. However, it is believed that if the blinding type is selected to be by introducing an unpredictable or “random” power as a “blinding exponent,” such as used in the protocols of FIG. 12, then a version of the protocol of the present FIG. 12B it is believed can be adapted: the proof that the base si is the same work when one or both public keys are blinded in this way. In the case where one of the public keys is “signed,” then it is believed possible to use the “un-signed” version of the public key in a proof with a cleartext public key and/or a blinded public key.

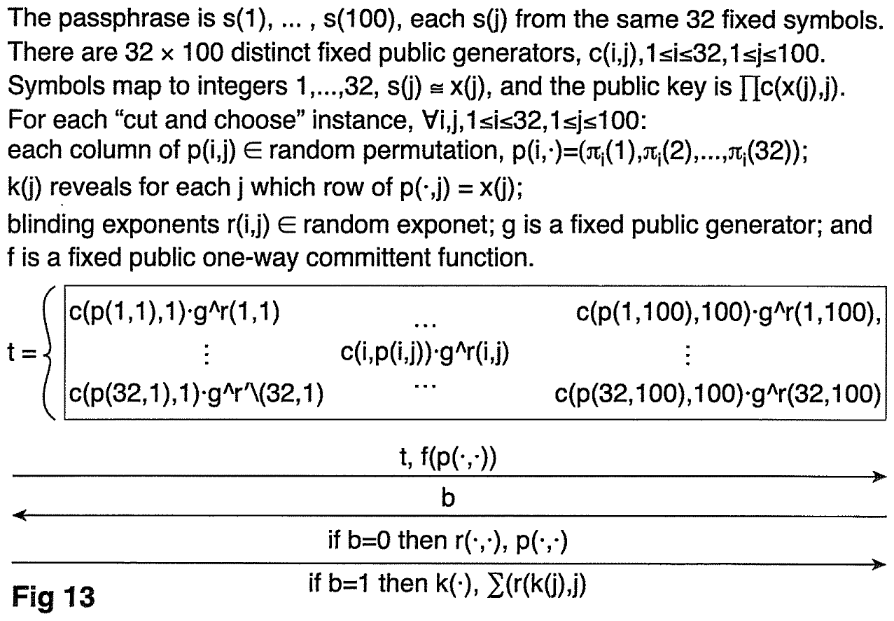

Turning now to FIG. 13, a detailed exemplary cut and choose cryptographic protocol diagram for establishing an inalienable public key is shown in accordance with aspects of the teachings of the invention. The example is for a passphrase alphabet of thirty two characters and a passphrase length of one hundred characters, again for concreteness and clarity but without loss of generality, and for a cryptographic proof that the corresponding public key is well formed.

The cryptographic protocol diagram is comprised of four vertically arranged sections: The setup section is shown first and includes portions that remain the same across the cut and choose instances; the second section contributes to defining the particulars of the cryptographic values that vary per instance of the cut and choose. The third section shows the table of values sent in the first protocol message of each instance of the cut and choose. The fourth section discloses the remaining exemplary cryptographic protocol challenge and response message parts of each instance of the cut and choose.

The example shown would typically be repeated some number of times with independent values and challenges, as is well known for such “cut and choose” cryptographic protocols; for instance, such protocols can be completed twenty times for significant confidence or one-hundred times, for extreme confidence.

Referring now first more specifically to the setup section, what can here be called “symbol” and/or “character” positions in the passphrase are one hundred in quantity, ordered, and each can be occupied by one of the fixed set of symbols available for all positions in the example for clarity, as mentioned. For instance, symbols can be comprised of letters in the roman alphabet (a-z) and a few extra common non-letters, such as exclamation mark(!), at symbol(@), comma(,), question mark(?), dash(-), apostrophe('). These one hundred symbols of the passphrase are shown as s(1), s(2), . . . , s(100), as will be understood. They can be mapped to the first thirty-two counting numbers, as will be understood, and called x: s(j)≅x(j), 1≤j≤100.

For each combination of character and position a randomly chosen generator in the cryptographic group is used here, for example the residue classes modulo a suitable large prime comprising a Diffie-Hellman system. The modulo representation notation is not repeated for clarity as is known in the art and as will be appreciated. These generators are shown as c(1,1), . . . c(32,100) or as c(i,j) where 1≤i≤32, 1≤j≤100. Sometimes this is referred to as the direct product, for instance of the characters and the positions, as is known. Each character and its position in the passphrase will thus have a unique cryptographic representation. It is here assumed that an adversary cannot feasibly know a multiplicative relation between any combination of what in the example is thirty-two hundred generators, which is believed to be a typical cryptographic assumption. Various ways to achieve this at least with high probability and resistance to attack are known, such as a public random draw that is post-mapped by a suitable one-way cryptographic function. More succinctly, it can be said that the direct product of character and position determines a random fixed distinct set of assumed independent generators in a so-called Diffie-Hellman discrete log group.

The public key of user u, at least for use with entity e, is established in a way that extends across the iterations of the cut and choose, as will be appreciated. In the example the public key should be the product of one hundred of the generators. The first of these generators is from the first thirty-two generators, c(i,1), the second from the second thirty-two (that is thirty-three through sixty-four), c(i,2), and so on as will be understood and as is shown. There is typically at least one natural ordering, such as the lexicographic ordering, of the symbols or characters; similarly, there is typically at least one natural ordering of the generators, such as by magnitude of least positive representative. The same position in such orderings can, for instance, be used for both the character and the generator, to bring them into pairs, as indicated by the mapping “≅”. This can be shown as x(j)≅c(i,j), where the j ranges over the full one hundred initial counting numbers and the value of i ranges over the thirty-two character choices, with one value of i for each value of j corresponding to the actual symbol s(j).

Referring now more specifically to the second section. The values of i and j range over the number of characters and positions, which may be shown as ∀i,j,1≤i≤32, 1≤j≤100. Each iteration is believed best to involve a fresh instance of the random values r, which is a table of thirty-two hundred exponent values, the additive group of residues modulo the order of the Diffie-Hellman group being used, defined with both i and j as subscripts. It should similarly involve a random permutation p. These arrays r and p should it is believed ideally be chosen by u, at least best unpredictably and ideally independently and at random, as is well known in cryptographic protocols. This is believed to provide that each respective generator corresponding to a passphrase character appears exactly once as in effect a factor in the public key.

The value of the vector k is believed determined, given the passphrase, by the respective p for that iteration. For each of the one hundred passphrase positions per cut-and-choose instance, there is ideally an independent and uniformly chosen permutation of the integers between one and thirty-two, sometimes denoted (πi(1), πi(2), . . . , πi(32)), exactly one of those positions maps to the character of the passphrase and is selected by the particular value of the respective k(j).

Each iteration involves a fresh instance of the random values r and the permutation p chosen by u. The value of the key vector k can be determined for each instance by p, as the indexes of the actual mapped passphrase character positions, which are row permuted in general differently per instance by p. Moreover, the product of the entries that are selected by k is the public key, or “pubkey” for short. This may be denoted Πc(x(j),j).

For convenience, f is a fixed public one-way commitment function, as are known. The multiplicative blinding can, as in the example, use a public generator fixed for the whole protocol, shown as g.

Referring now to the third section, the table, which is sent from u to e as indicated by the right-pointing arrow and the symbol t, is to be described further. (Not shown for clarity, but user u is the party on the left in the protocol and entity e that on the right.) There are thirty-two rows and one hundred columns in the example table t. Almost all entries in a column, thirty one, apart from the actual passphrase entry, will not be used to form the public key; only one entry per column, the one selected by k, k(j) for column j, is so used. For that entry, the generator from c is blinded by the r power of g, as will be appreciated.

The table t is formatted to show for clarity a collection of cryptographic values. These could be encoded for convenience, for instance, in an example implementation as a vector of thirty-two hundred numbers in row major order. The corners of the rectangle in the figure are specific boundary values: those with the lowest indexes in the upper left, those with the highest in the lower right, and so forth. In the center is the general form of an entry, c(i,p(i,j))·g\hat{ }r(i,j). The c generator is determined by p, as mentioned. The blinding factor, g raised to the power r, as shown by the standard caret notation “\hat{ }”, as will be understood to be in the example cryptographic group.

Referring finally to the fourth section, after the table and commit to p(i,j) has been sent by u to e, a so-called “challenge” is sent by e to u. In the example for clarity, there are two cases: e requests to see all the blinding exponents by sending b equal zero; or, as indicated by a challenge where b equals one, e requests to see which row of t is the actual passphrase character and also the sum of all the blinding exponents. In the first case, the value of r and p are supplied by u to e. In the second case, u conveys to e, for each column, which row the actual passphrase character is in, by supplying k. Also in this case u provides in effect a combined exponent for all the blinding factors, by supplying the sum of the blinding exponents (as usual modulo the order of the group for improved hiding) that are applicable to the selected rows, as will be understood.

In the first case, e can directly check the values received by re-construing them from r and using p (once verified as having been properly committed) to see that they contain the proper c, as will be understood. In the second case, u provides the sum of all the r that appear as exponents of g for the k-selected row per column. The second case is thus believed to allow e to compute the public key as the product of all the generators corresponding to the passphrase, one per character, and also to remove all the multiplicative blinding resulting from powers of g and thereby recover the public key of u.

In addition, optionally and not shown for clarity, such as in a use of the public key, e provides a power of all the generators of c and then u provides back that same power of the public key. This is believed an example way to confirm that u can represent the public key as at least a product of powers of generators in c.

In some example uses, it is believed potentially safe and useful for the generator z to be made public with the signature exponent on it. The user u can register the original, non-clocked, password with one organization and clocked versions with other organizations, each of the other organizations having a particular fixed and distinct clocking value that they use to distinguish their users in some examples. When a signature is formed on the blinded form of the un-clocked public key, it can thus be transformed by the user to the same signature (i.e., secret power) on the other differently blinded form of the same un-clocked signature that user u has registered with the other organizations. The issuer of this signature can be called on by the recipient organization to then verify the pair comprised of the signature and unsigned blinded public key are related by the organization's secret signing exponent.

A signature can be issued by an e on a blinded pubkey by providing u with the pubkey raised to the secret signing power of e. Furthermore, e can make public z to that signing power. Then u can show that same secret power to a differently blinded form of the pubkey that is known to a second entity, e2. Such showing would be by so-called “re-blinding” as is known, changing the exponent on z between the one shown to e and that to e2. Furthermore, u could provide e2 with a zero-knowledge proof that a clocked variation on the blinded pubkey resulted in a pubkey that can be used to identify u to e2. Combined, this results in what the present author has called a “credential mechanism” in the literature, as will be understood. In particular, for instance, each eᵢ would have a so-called “digital pseudonym” corresponding to the clocking variation, thereby ensuring that a single person does not have more than one as all those for that singe organization in the example would have the same pubkey clocking variation. Moreover, a signature issued on a blinded form of the pubkey that is shown blinded, for instance always from e, would then be showable on any other blinded form of that same pubkey established with other eᵢ by u, when g is also made available with that signature exponent. In some examples the signatures can be verified by any eᵢ by checking with the issuer, who can perform a zero-knowledge proof that the blinded pubkey is in fact raised to the secret power in the signature value, as mentioned.

It will further be appreciated that various such credential signatures, from more than one user, can be combined by a so-called “multiparty computation” into a signature that reflects a predicate or other function on the underlying signatures. This can, in some examples, even be accomplished while keeping at least some of the information used by the multiparty computation from at least some of the users whose credentials are input.

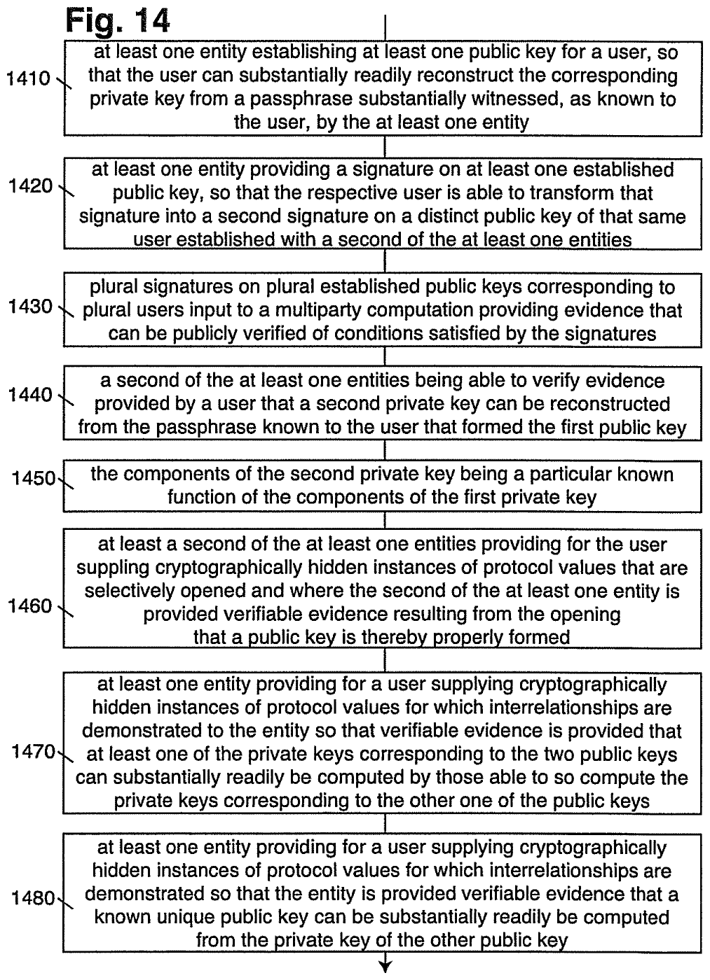

Turning next to FIG. 14, a combination flowchart and block diagram of an exemplary inalienable credential mechanism is shown in accordance with aspects of the teachings of the present invention.

Referring to box 1410, it can here be said that “In a cryptographic protocol between each of a plurality of users and at least one entity, comprising: the at least one entity establishing at least one public key for a user, so that the user can reconstruct the corresponding private key from a passphrase substantially witnessed by the at least one entity as known to the user,” to mean that the at least one entity is able to develop significant confidence that the user knows a passphrase or the like that would enable the user to feasibly and/or readily compute the private key that corresponds to the public key.

Referring to box 1420, it can here be said that “at least one entity providing a signature on at least one established public key, so that the respective user is able to transform that signature into a second signature on a distinct public key of that same user established with a second of the at least one entities, optionally in some examples with the same passphrase,” to mean that a user can be provided with a signature that the user can transform between the public keys, and optionally in some examples where the public keys are related because the corresponding private keys are made with the same knowledge of the same passphrase.

Referring to box 1430, it can here be said that “plural signatures on plural established public keys corresponding to plural users input to a multiparty computation providing evidence that can be publicly verified of conditions satisfied by the signatures,” to mean that multiple credential signatures, from multiple users, are combined by those users with a multiparty cryptographic protocol so that at least one signature and/or authentication results that represents a combination of the inputs and where the particular predicate satisfied by the combination may or may not be known to the participating users.

Referring to box 1440, it can here be said that “a second of the at least one entity being able to verify evidence provided by a user that a second public key can be reconstructed from the passphrase by the user that formed the first public key,” to mean that the second entity can check a cryptographic proof and/or protocol that confirms the user can obtain the private key corresponding to a second public key from the same passphrase as used for another key pair.

Referring to box 1450, it can here be said that “the components of the second public key being a particular known function of the components of the first public key,” to mean that a user can provide evidence that is convincing to an entity that the parts, such as passphrase portions, used to form a particular public key, whether or not shown in blinded form, are able to be used by the user to form a second public key.

Referring to box 1460, it can here be said that “at least a second of the at least one entities providing for the user suppling cryptographically hidden instances of protocol values that are selectively opened and where the second of the at least one entity is provided verifiable evidence resulting from the opening that a public key is thereby properly formed,” to mean that a protocol is conducted between a user and an entity in which selective opening of committed values provided by the user to the entity establishes evidence that should be convincing to the entity that the public key is properly formed.

Referring to box 1470, it can here be said that “at least one entity providing for a user supplying cryptographically hidden instances of protocol values for which interrelationships are demonstrated to the entity so that verifiable evidence is provided that at least one of the private keys corresponding to the two public keys can be computed by those able to substantially readily compute the private keys corresponding to the other one of the public keys,” to mean that a user can convince an entity that two public keys have private keys that can be computed from the same passphrase and/or that the user can convince the entity that the public keys have a particular relationship between them.

Referring to box 1480, it can here be said that “at least one entity providing for a user supplying cryptographically hidden instances of protocol values for which interrelationships are demonstrated so that the entity is provided verifiable evidence that a known unique public key can be substantially readily be computed from the private key of the other public key,” to mean that when one public key is shown to an entity another public key with the same passphrase can be demonstrated and the relationship between the two public keys is proved, such as in zero knowledge, to be unique and according for instance to a particular agree function relation.

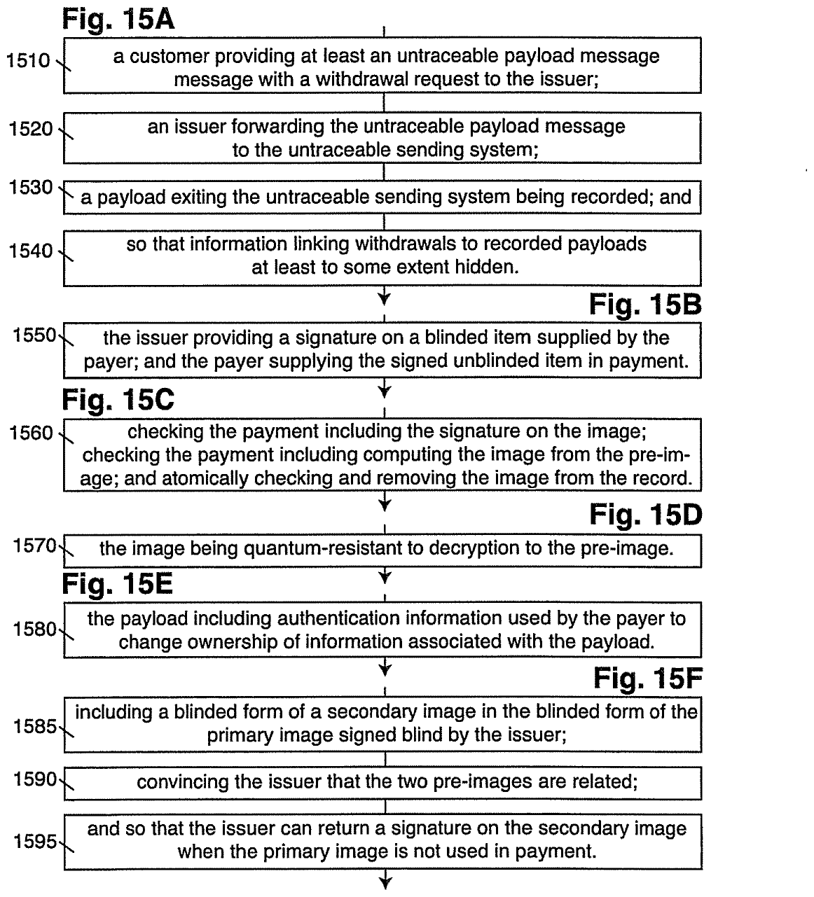

Turning now to FIGS. 15A-F, an exemplary combination flowchart and block diagram of a cryptographic protocol for value transfer is shown in accordance with the teachings of the invention. FIG. 15A is a value transfer system generally involving an untraceable sending to recordation; FIG. 15B is the system including a blind signature protocol; 15C is the atomic checking for the presence of an image before accepting a transfer; 15D is a quantum-resistant formation of the image; 15E is the transfer of the value based on the recorded authentication information; and FIG. 15F is inclusion of authentication of a secondary image within a primary image.

For the purposes of clarity in the present application various terms have been used that may be more familiar in the art but, as will also be appreciated, the particular choice of terms applicant chooses to give precedence to here for purposes of the present FIGS. 15A-F and the appended claims are as follows:

The term “issuer” is used here to mean the bank, whether for instance commercial or central, or other entity that is controlling the issuance of the electronic value or payment media to the customer.

The term “customer” is used here to mean the payer and/or the user and/or whatever party or entity withdraws value from the issuer for later spending.

The term “payee” is used here to mean the merchant and/or receiver of value and/or whatever party or entity receives value from the customer in the protocols.

The term “untraceable-sending system” is used here to mean whatever mixing system or the like that at least obscures the relationship between messages provided to it as input from those provided by it as output.

The term “untraceable payload” is used here to mean the data and/or information element and/or portion of a cryptographic message that is submitted to an untraceable-sending system with the intended and/or actual result that it emerges from the sending system, such as where it emerges in plaintext and/or encrypted form.

The term “recorded” is used here to mean whatever means or method for preserving information content, such as but not limited to a database and/or a blockchain.

The term “item” is used here to mean for instance the element of a set of elements that can be used to represent individual instances of a cryptographic values, such as for instance as are well known but not limited to the least positive representative of a particular multiplicative group and/or residue classes of a large composite of secret factorization.

The term “primary image” is used here to mean, referring to FIG. 1B, for instance the public key s.

The term “secondary image” is used here to mean for instance the public key t.

Referring now to FIG. 15A, and more specifically to box 1510 it may here be said that “a customer providing at least an untraceable payload message entity with a withdrawal request to the issuer” to mean that the customer sends, along with whatever withdrawal request, information prepared to be input to an untraceable sending system, such as but not limited to a mix network or c-mix cascade; presumably the customer has used information in preparing the message that is kept from some parties and the lack of this information keeps those parties from readily tracing the payload included in the untraceable sending.

Referring to 1520 it may here be said that “an issuer forwarding the untraceable payload message to the untraceable sending system” to mean that the issuer, such as a bank, can control the entry node or otherwise control or limit what is included in the untraceable sending system in whatever way to limit what payload(s) are able to appear in the output and/or as output of the exit node.

Referring to 1530 it may here be said that “a payload exiting the untraceable sending system being recorded” to mean that an output related to a payload related to an input is saved in a database and/or entered on a blockchain and/or otherwise stored in some embodiments whether publicly and/or privately.

Referring to 1540 it may here be said that “so that information linking withdrawals to recorded payloads at least to some extent hidden” to mean that the items entering the entry node(s) of the untraceable sending system are ideally not readily linked to the corresponding output leaving the exit node(s) of the untraceable sending system, which is the function of such system.

Referring to FIG. 15B, and more specifically to box 1550 it may here be said that “the issuer providing a signature on a blinded item supplied by the payer, and the payer supplying the signed unblinded item in payment” to mean that the issuer is able to transfer authentication information for a particular element that the issuer is not exposed to by the payer, such as in a blind signature system.

Referring to FIG. 15C, and more specifically to box 1560 it may here be said that “checking the payment including the signature on the image, checking the payment including computing the image from the pre-image, and atomically checking and removing the image from the record” to mean that when a payment is received from a payer the payer provides a pre-image and the corresponding function is then at least checked that it is applied to the pre-image to result in the image that is stored; when the stored image is checked for and it is found the storage system is changed so that it cannot be found again, so it can only be found one time and this is aimed at preventing double spending.

Referring to FIG. 15D, and more specifically to box 1570 it may here be said that “the image being quantum-resistant to decryption to the pre-image” to mean that the function that transforms the pre-image to the image is selected and/or of such a nature as to be believed to be infeasible to invert even using a quantum computer.

Referring to FIG. 15E, and more specifically to box 1580 it may here be said that “the payload including authentication information used by the payer to change ownership of information associated with the payload” to mean that the payload contains authentication information, such as so-called “public keys” or the like, so that payer that formed the payload originally retains an ability to form authenticators, such as so-called “digital signatures” or the like, to establish ownership and/or request transfer of all or part of the value recorded to another ownership and/or form of authentication.

Referring to FIG. 15F, and more specifically to box 1585 it may here be said that “including a blinded form of a secondary image in the blinded form of the primary image signed blind by the issuer” to mean that the blinded element supplied includes encoded within it, directly or indirectly, a secondary blinded element.

Referring to 1590 it may here be said that “convincing the issuer that the two pre-images are related” to mean that the issuer obtains some confidence that the primary image and the secondary image are related to the extent that either one of them, but only one of them, will be accepted in payment.

Referring to 1595 it may here be said that “and so that the issuer can return a signature on the secondary image when the primary image is not used in payment” to mean that the issuer can verify that the primary was authenticated, such as signed in a blinded form, and that the primary did contain the secondary, so that the secondary is also properly formed to the extent that the primary was checked as being properly formed.

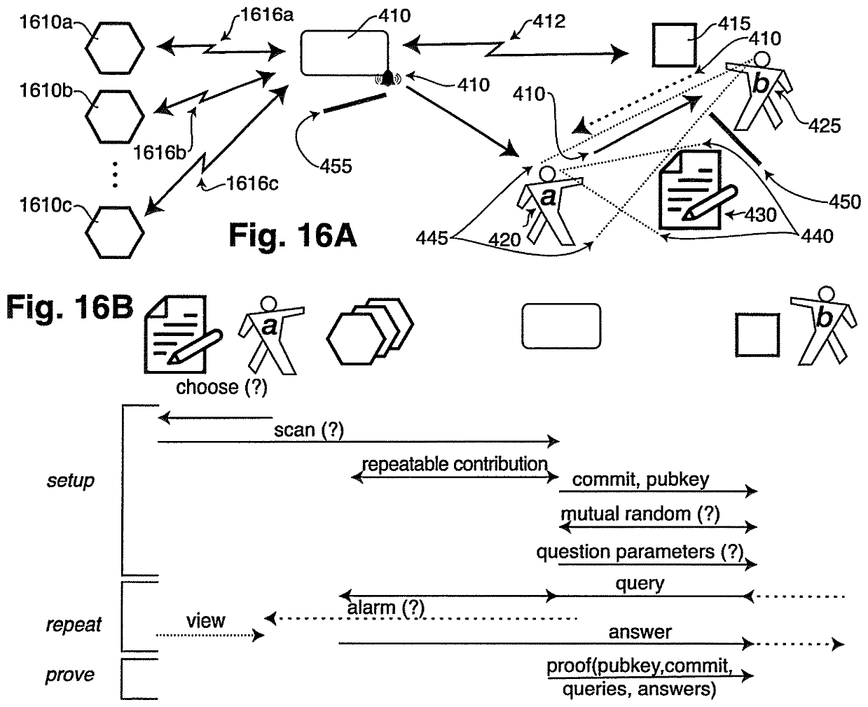

Turning now to FIGS. 16A-16B, overall combination cryptographic diagram, block diagram, plan view, and ladder diagram, for inalienable key establishing with repeatable contribution are shown in accordance with the teachings of the present invention. It will be appreciated that FIG. 16A is similar to FIG. 4A, apart from the elements called out with numerals beginning with sixteen instead of four; FIG. 16B includes and elaborates on those new elements and also includes them in the proof.

In some cases, it is believed a concern that some persons may choose secrets that are too easily arrived at by those attempting to obtain keys. An example non-limiting way to counter such what can here be called “weak secrets” disclosed with reference to the present figure is the use of one or more what may be called “contributing parties” to provide additional entropy. It is believed that one consideration is that the contributing parties should not be able to learn the identity of the person they are contributing on behalf of, otherwise anonymity may be more difficult to achieve in cases where it is desired. Another consideration is believed to be that some of the contributing parties may be absent in some instances when needed. A yet further consideration is believed to be that the contributing parties may collude among themselves in an effort to recover the keys of persons that with weak secrets.

Referring first to FIG. 16A, in the exemplary embodiment detailed the person's phone 410 communicates blinded values of the secret to the one or more contributing parties 1610a, 1610b, and so forth through to 1610c. These parties return digitally signed versions of the blinded values to the phone. (Blind signatures, first disclosed in U.S. Pat. No. 4,759,063, by the present applicant, are well known and quantum resistant variants have it is believed been proposed.) The bidirectional communication between the parties is shown as 1616a through 1616c, respectively. Upon unblinding the signatures, the phone combines them, such as multiplicatively, to form a value that is included with secret in forming the public key. Thus, as will be appreciated, the product of the signatures on the secret will be “repeatable” for any number of instances involving the same contributors. Also, as will be appreciated, the contributors learn essentially nothing additional about the secret or the identity of the person 420 through the protocol.

Referring now to FIG. 16B, the contributing parties are shown as hexagons 1610a-c along the top between the person 420 and the phone 410. The double-ended arrow shows the sending of the blinded secret by the phone to the contributing parties and the return of the signed-blinded value, all labeled “contribution” for clarity. The commit includes in this case the combination, such as by concatenation, of the combined signature of the contributing parties with the secret from the person; the pair comprising a value and its repeatable contribution signature. The proof includes, as will be understood, confirmation that the signed version of the secret, the “contribution,” is in fact well formed from the secret. For clarity, in FIG. 4B, the secret being included in the commit was not called out explicitly for clarity; the secret and contribution are shown here in FIG. 16B as part of the committed value.

In some variations, the contributing parties can determine that one or more of their number are absent and, using known cryptographic protocols such as secret sharing and/or multi-party computation, provide that the combination of the signatures of the then active parties result in the same original desired combined signature, as will be readily understood. It will also be appreciated that if the person includes a public portion in their secret, such as their name, then this it is believed serves like so-called “salt” in password encryption schemes, requiring separate efforts to search for each person's keys. It will also be appreciated that the signature returned by the contributors would benefit from requiring much computation, as is also known from password encryption schemes. One non-limiting example approach to achieve this would be the use of large parameters in the signature scheme.

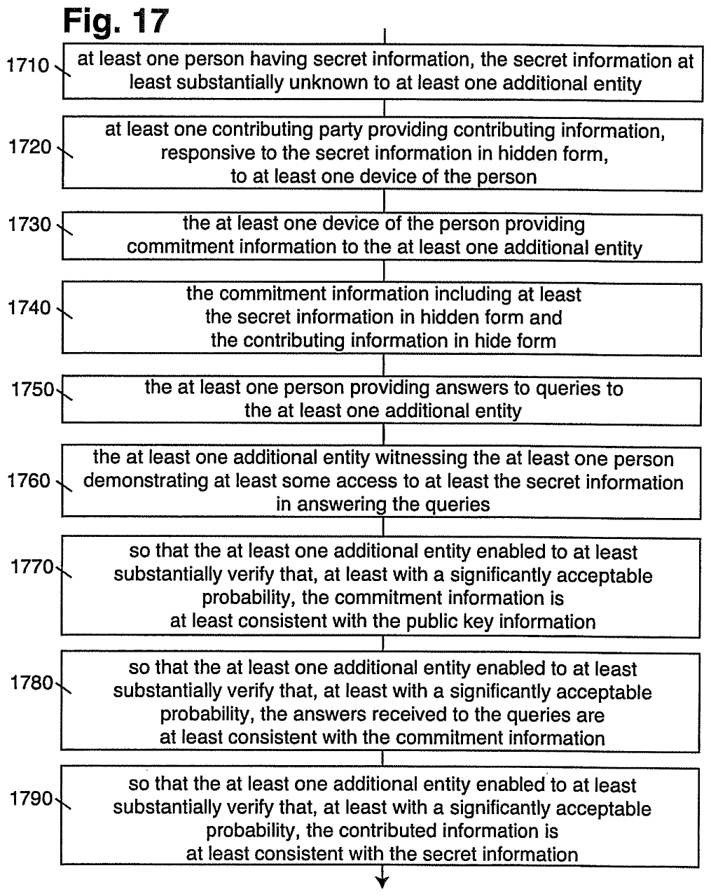

Turning finally now to FIG. 17, an overall flowchart and process steps for inalienable key establishing with optional repeatable contribution is shown in accordance with the teachings of the present invention.

Referring to box 1710, it can here be said that “at least one person having secret information, the secret information at least substantially unknown to at least one additional entity” to mean that a secret, such as a passphrase, is ideally memorized by the person; however, the form of the secret can be whatever information.

Referring to box 1720, it can here be said that “at least one contributing party providing contributing information, responsive to the secret information in hidden form, to at least one device of the person” to mean that the optional contributing party or parties receive the secret information in a hidden form, such as for instance blinded, and return information that allows the device of the person to obtain the contribution in a repeatable form and in a way that is ideally responsive to the secret information. For instance, the contributing parties receive blinded forms of the person's secret and return their signatures on them; unblinding allows the device of the person to combine the signatures in a repeatable way and include the combination in the commitment information.

Referring to box 1730, it can here be said that “the at least one device of the person providing commitment information to the at least one additional entity” to mean that one or more devices of the person communicates encrypted or otherwise hashed information to the at least one additional entity.

Referring to box 1740, it can here be said that “the commitment information including at least the secret information in hidden form and the contributing information in hidden form” to mean that ideally the information conveyed in box 1730 locks in the included information, such as the secret information and contributed information, to prevent it from later being changed, while still allowing proofs about the included information, such as SNARK's, to be made by the user device about the included information

Referring to box 1750, it can here be said that “the at least one person providing answers to queries to the at least one additional entity” to mean that questions related to the secret, such as characters and/or other indicia making up the secret, can be asked about, such as by position or number of occurrences or adjacency, and the responses provided to the additional entity.

Referring to box 1760, it can here be said that “the at least one additional entity witnessing the at least one person demonstrating at least some access to at least the secret information by answering the queries” to mean that the answers to queries are provided at least ideally in a way that the additional entity can verify that the person is not obtaining them from a device other than ideally where the person had written them from memory.

Referring to box 1770, it can here be said that “so that the at least one additional entity enabled to at least substantially verify that, at least with a significantly acceptable probability, the commitment information is at least consistent with the public key information” to mean that the at least one additional entity is able to verify a cryptographic proof that the commitment information includes the public key information in the prescribed manner.

Referring to box 1780, it can here be said that “so that the at least one additional entity enabled to at least substantially verify that, at least with a significantly acceptable probability, the answers received to the queries are at least consistent with the commitment information” to mean that the at least one additional entity is able to verify a cryptographic proof that the commitment information includes secret information that corresponds with the particular query responses received.

Referring to box 1790, it can here be said that “so that the at least one additional entity enabled to at least substantially verify that, at least with a significantly acceptable probability, the contributed information is at least consistent with the secret information” to mean that the at least one additional entity is able to verify a cryptographic proof that the commitment information includes secret information that corresponds with the secret information.

The system architecture can also be described as follows. Users interact with an inalienable service to generate and verify a unique “inalienable” key pair. Upon successfully generating a key pair, users interact with their own commercial bank to perform CBDC withdrawals, or with a merchant to perform the purchase of goods or services.

Merchants, on the other hand, receive purchase requests from users, and communicate with their commercial bank to perform the clearance of received payments. The commercial banks, both the user's and the merchant's banks, communicate with a central bank.

The central bank, which acts as an authority for the commercial banks, performs read and write operations by interacting with an allow list service, and posts data on a blockchain using a mix network.

The mix network is used to preserve privacy while addressing the threat of a quantum computer being used in counterfeiting. Every coin is formed using a one-way function and is forwarded through a mix network to be checked against a database, that is kept by the central bank, of spent coins.

It is also highlighted that, while a blockchain is not strictly needed as a place to publish the hashes that are output by the mix network, it does provide a robust storage solution that can be infeasible to corrupt in practice.

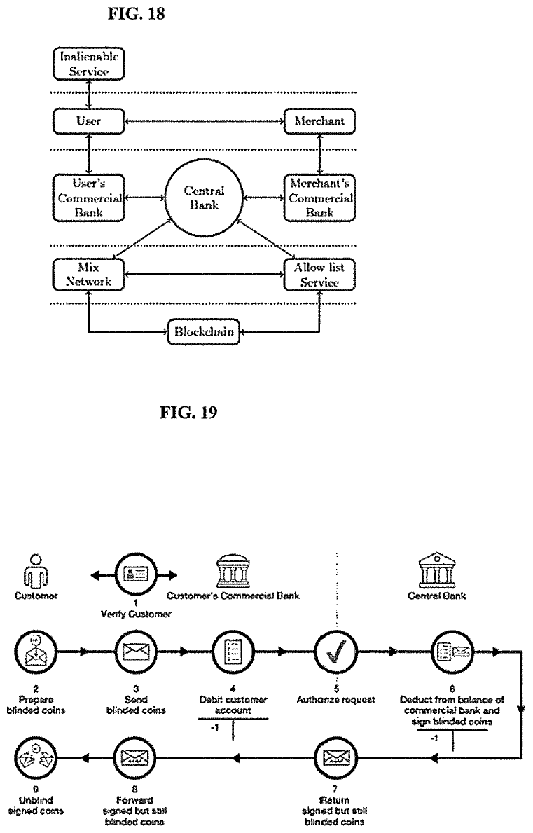

FIG. 18 shows an architecture diagram of the system. The top row, exposes the services accessed by the user(s). Below, on the second row, the diagram exposes the end clients that exist in the system: users and merchants. The third row contains all the banks that comprise the entire system: user's commercial bank, merchant's commercial bank, and the central bank. The fourth row, describes the service entities used by the central bank: a mix network and an allow list service. Finally, on the bottom row, the diagram features a blockchain to act as a secure and censorship-resistant storage component.

One primary objective of this architecture is to allow for a system where central banks do not have to interact directly with customers. Rather, authentication is delegated to commercial banks that already have the necessary infrastructure in place. Withdrawal and payment protocols are the only two that need interaction with the central bank, each through a commercial bank as intermediary. Therefore, before a central bank signs a coin into existence for a commercial bank's customer, that customer has been authenticated and the corresponding amount withdrawn from the customer's account at the commercial bank.

The withdrawal phase and payment phases discussed above are also described below. In the withdrawal protocol, the protocol assumes a setup phase where the central bank generates an RSA public-key pair using a modulus N and distributes the public key to the users of the system. It should be noted that e represents the public exponent and d is the private signing key. It is also assumed that the central bank has one signing key for each coin denomination. The withdrawal protocol is described in more detail below and in FIG. 19.

To perform a withdrawal of a single denominated coin (see FIG. 19), user Alice performs the following steps:
1) authenticates to commercial bank by using the corresponding authentication procedures;
2) generates a random preimage: x [symbol] {0, 1}n;
3) applies a hash function H to the preimage to obtain a coin c=H(x);
4) generates a random blinding factor r;
5) computes a blinded coin be by multiplying the blinding factor raised to the public key of the bank by the generated coin: bc=cr^{e} mod N; and
6) sends a withdrawal request containing the blinded coin to said bank, which debits the account for that amount.

The commercial bank relays the blinded coin to central bank.

The central bank deducts the value of the coin from the commercial bank's account at the central bank, signs the coin, and returns the blinded signature to the commercial bank.

The commercial bank forwards the blind signature to Alice.

Alice unblinds the signature and stores the newly minted signed coin c*.

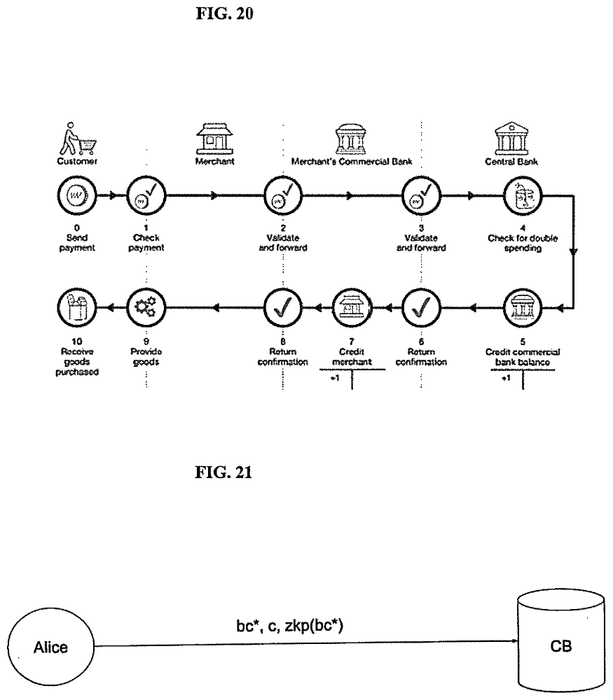

The payment protocol, which entails the spending process of the Central Bank, which is also analogous to paying merchants with cash, is detailed below and shown in FIG. 20.

To initiate a payment (see FIG. 20), a customer selects goods they wish to buy and the merchant creates a transaction identifier tx_{id} for this purchase. The merchant then sends this identifier to customer Alice.

To perform such a payment, Alice performs the following steps:
1) creates a transaction tx by creating a tuple containing the preimage x, the transaction identifier tx_{id}, and a single hash digest of the identifier and the signed coin: tx=x, tx_{id}, H(tx_{id}, c*);
2) sends the transaction to the merchant.

The merchant validates the payment details and relays the transaction along with the merchant's account information to its commercial bank.

The commercial bank of the merchant validates that this message originates from one of its merchants and relays the transaction to Central Bank.

The Central Bank, upon receiving the transaction from the merchant, performs the following steps:
1) applies hash function H to received preimage x and obtains coin c;
2) signs coin c to obtain signed coin c*;
3) checks for double spending by checking in the storage layer if coin c is in the list of allowed coins C;
4) produces a hash digest of the transaction identifier and the signed coin: 7i(tx_{id}, c*);
5) checks if the obtained hash digest from previous step matches the hash digest received in the transaction relayed by the merchant;
6) returns an approval on the transaction if all the above checks are successful and credits the commercial bank's account at the central bank.

The commercial bank credits the merchant's account and informs the merchant that the transaction is valid.

The merchant releases the product(s) to the customer.

Change Transactions noted above are also described. In real-world payments, it is often the case that users do not have the exact change for specific transactions. In the real-world, users typically pay using a higher denomination and the service provider returns the corresponding change amount back to the user. The inventive digital currency system handles the scenario where a user only has higher denominations, by having the digital wallet of the user periodically query the corresponding bank to split the higher amount denominations into smaller coins. This splitting process then allows users to be able to perform the specific payments.

The system also provides the following in terms of security.

Discreditation. To mitigate the risk of a user (or an entity) attempting to discredit the platform, the system requires users to provide zero-knowledge proofs of correct encryption before the mix network processing to ensure that there is accountability and that no user is able to submit a malicious payload and incorrectly blame a mix node for not processing a message correctly. Additionally, the system utilizes a mix network that provides verifiability and thus allows users to verify that the correct operations are applied during the processing of each batch of messages.

Traceability. After the payment operations, which account the value was withdrawn from remains hidden because of the applied blinding factors. However, since the payer knows the preimage x, then the payer can simply reveal x (or a property cryptographically hidden in the preimage) to allow the beneficiary of the payment to be traced.

Redemption Hijacking. Initial e-cash designs rely simply on sending the preimage along with the signed coin. This, however, allows for a malicious intermediary to perform a hijacking of the redemption process as all the necessary information to claim the digital money is sent in that specific payload. By sending the hash digest of an identifier and the signed coin instead, the central bank can check the transaction is well-formed while ensuring that no sensitive information is leaked to intermediary parties.

Quantum Security and Counterfeiting. The system employs cryptographically secure one-way functions that are resistant against quantum algorithms when instantiated with the appropriate security parameters. As a result, a quantum adversary A is not able to forge a coin that is present on the list of valid coins as A must find a second preimage, which is considered unfeasible for this quantum adversary. The adversary, however, is theoretically able to obtain the prime factorization of the used RSA modulus. The knowledge of such factorization allows the adversary to sign on behalf of the Central Bank. We note, however, that A is not able to create spendable coins using the compromised keys as this requires submitting malicious payloads through the mix, which requires subverting the mix network service. This violates the correctness property of the mix network and is also considered unfeasible for such an adversary.

The inventive CBDC should preserve at least low-value cash-like transactions as a privacy-friendly commons under citizens' individual control. With the inventive system, central banks can provide the privacy consumers have shown they care deeply about, while preventing large-scale abuse, with all the advantages of a state-of-the-art CBDC and quantum-resistant security against counterfeiting.

The inalienable signatures noted above are also described below.

The inventive digital currently also provides a new construction that allows users to generate an asymmetric key pair from a password (or passphrase). The core idea of the protocol is that a user picks a sequence of characters, where each character is mapped to one of the public generator values. Alternatively, the reader may visualize each of the public generator values as a fixed-public key value with a private exponent that is public and deterministic on a per index basis.

The resulting secret key is the hash of the concatenation of each private exponent value, and the public key is obtained by raising the public generator of the group to the private key (hash digest value). Since users know the discrete log associated with the obtained public key and the private key is obtained from a sequence of character, then a user can produce signatures by proving knowledge of the corresponding private key. Moreover, users are able to deterministically generate such key pair from their password (or passphrase).

The Table below is an example table containing the public-private key parts for a three-character password setting. In this case, users only have four possibilities for each of the character.

TABLE
Public table containing the key parts to be used in key generation.
Without loss of generality, this approach is flexible to
a variable security parameter (i.e., more characters) based
on the corresponding usability/security trade-off.

| 1 | 2 | 3 | 4 |
|---|---|---|---|
| z(1, 1) | z(1, 2) | z(1, 3) | z(1, 4) |
| z(2, 1) | z(2, 2) | z(2, 3) | z(2, 4) |
| z(3, 1) | z(3, 2) | z(3, 3) | z(3, 4) |

Private key values. The z values are public and are generated using a nothing-up-my-sleeve approach. For example, to generate each of the individual z values, the system can potentially use a cryptographically secure hash function H, two fixed public random values x and y, along with the row and column indexes. We highlight that the hash function must be instantiated with appropriate security parameters.

Below, an example of a possible generation mechanism of each of the private key parts using random public (x, y) values is provided:

$$z ( i , j ) = ℋ ( x ‖ i ‖ y ‖ j )$$

Key pair. To obtain a secret key sk, the user hashes each of the private key parts that are associated with the chosen characters in the password (or passphrase).

Upon completion of the secret key generation, the user applies the trapdoor operation of the corresponding group and obtains the associated public key pk. Therefore, the corresponding key pair (sk, pk) is generated as exposed in the example below:

$$\{ \begin{matrix}sk = ℋ ( z ( 1 , \text{*)} ‖ z ( 2 , \text{*)} ‖ z ( … , \text{*)} ‖ z ( n , \text{*)} ) \\ ρ k = {g}^{sk} mod p\end{matrix}$$

Three-digit password example. To generate a key pair from the password “431”, user Alice selects the key value corresponding to the first character (4) in the corresponding table: z(1, 4). For the second private key part, Alice selects the corresponding value for the second character (3): z(2, 3). Finally, for the third secret key part, Alice selects the corresponding value for the third character (1): z(3, 1). As a result, the final secret key value is the hash of all three private key parts.

For a real world deployment, this scheme requires more characters and more individual options for each character to achieve the required real-world security.

A further discussion of the zero knowledge proof aspect of the invention is provided here. Upon completing the key generation, Alice, the owner of the key pair, should be able to successfully prove—in zero knowledge—the following statement: “I know a set of characters that allow me to deterministically derive a private key for a specific public key. Moreover, each of these chosen characters corresponds to one and only one character from every row of the public table (which contains the mapping from characters to key values).” A verifier, upon checking the correctness of such proof can then ask the signer to produce a signature on specific messages.

Referring to FIG. 21, a diagram is provided regarding a transaction that involves change. In this, a coin c is provided by a person, Alice, to make a payment, with a request to send back the change to bc* (by signing bc* with the appropriate signing key for the corresponding amount). To show that Alice is the owner of bc*, a zero knowledge proof is shown to prove that the Alice used their inalienable secret key to generate the blinding factor b and coin c* without revealing any of these factors.

With user Alice trying to perform a transaction that involves change, the Central Bank must be able to return at least one signed coin back to Alice in this transaction. It is assumed that Alice already has a coin c of higher denomination to perform the payment and an inalienable key pair (sk,pk). To obtain change, Alice generates another coin c*, a blinding factor skip, and multiplies the blinding factor by the coin. The generation of the blinding factor and the new coin uses the inalienable key pair as input of some derivation function. As a result, Alice can subsequently prove that she used her inalienable key to generate the blinded coin bc*.

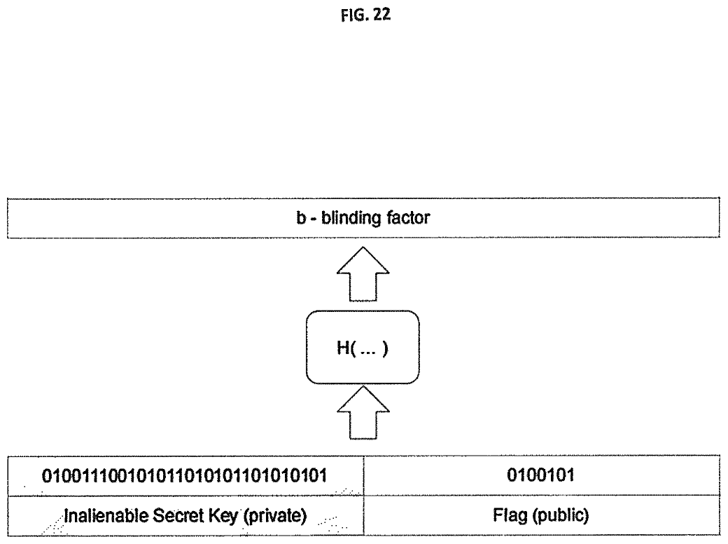

FIG. 22 illustrates generating the blinding factor b, wherein an inalienable secret or private key and a flag or public key are shown. The object is to prove in zero knowledge the following statement: “I know a private inalienable key value that, when hashed with the specific public flag value that I am revealing now, results in a blinding factor b.” Assuming that H is a second preimage resistant hash function, then this statement should be binding. Therefore, only the true owner of the inalienable key should be able to prove this statement.

All manner of equivalents and extensions are anticipated, including the use of cryptographic primitives, such as discrete log, instead of RSA. As just another example, registration for voting in one or more elections, where the voter registering establishes knowledge of one or more keys that can be used to cast votes and when more elections are to be included that voter can establish the equivalence of further keys that are essentially independent at least in terms of voter privacy.

1-31. (canceled)

32. In a cryptographic protocol for value transfer including at least a withdrawer party and a signing party, comprising:
performing a withdrawal instance of a private payment protocol;
withdrawer forming a payload related to the withdrawal instance;
payload formed by withdrawer sent through untraceability means;
so that the sending of the payload through the untraceability means subject to limitation by at least a party apart from the withdrawer;
so that the payload output by the untraceability means validates substantially a single payment authenticator; and
so that the payment authenticator is substantially difficult to derive from the payload.

33. The cryptographic protocol for value transfer of 32, comprising: so that the difficulty of deriving the payment authenticator from the payload at least includes inverting an at least substantially one-way function.

34. The method of 33, comprising the one-way function being quantum resistant.

35-38. (canceled)

39. In a cryptographic method conducted between a person, a device of the person, and at least an additional entity, the steps of:
at least one person at least having secret information;
the secret information at least substantially known to at least a first device;
the secret information at least substantially unknown to at least a second device;
the first device providing public key information to the second device;
the second device providing query information to the at least one person;
the at least one person providing answer information to the second device; and
so that the at least second device enabled to learn, at least with a significantly acceptable probability, that the secret information allows substantially ready computation of the private key information related to the public key information.

40. The cryptographic protocol of 39, comprising: plural queries and plural responsive answers.

41. The cryptographic protocol of 39, comprising: at least one subsidiary device with access to a least an aspect of the secret information that is secret from the first device; and the at least one subsidiary device providing information to the at least one first device cooperating in proving that the secret information allows substantially ready computation of the private key information related to the public key information.

42-59. (canceled)
